(19) United States
(12) Patent Application Publication
(10) Pub. No.: US 2024/0414681 A1
(43) Pub. Date: Dec. 12, 2024

(54) SCHEDULING REQUEST DESIGN FOR POSITIONING REFERENCE SIGNAL (PRS) MEASUREMENT REPORTS

(71) Applicant: QUALCOMM Incorporated, San Diego, CA (US)

(72) Inventors: Jingchao BAO, San Diego, CA (US); Sony AKKARAKARAN, Poway, CA (US); Sven FISCHER, Nuremberg (DE); Tao LUO, San Diego, CA (US); Juan MONTOJO, San Diego, CA (US); Alexandros MANOLAKOS, Athens (GR)

(21) Appl. No.: 18/695,117

(22) PCT Filed: Aug. 3, 2022
(86) PCT No.: PCT/US2022/074454

§ 371 Date: Mar. 25, 2024

(30) Foreign Application Priority Data
Sep. 30, 2021 (GR) 20210100650

(51) Int. Cl. H04W 64/00; H04L 5/00; H04W 24/10; H04W 28/02; H04W 72/1268; H04W 72/51

(52) U.S. Cl. CPC H04W 64/00; H04L 5/0051; H04W 24/10; H04W 28/0278; H04W 72/1268; H04W 72/51

(57) ABSTRACT

Disclosed are techniques for wireless positioning. In an aspect, a user equipment (UE) receives, from a location server, a positioning reference signal (PRS) configuration indicating one or more PRS resources to be measured by the UE, transmits, to a base station serving the UE, measurement report payload related information based on the PRS configuration, obtains positioning measurements of the one or more PRS resources, transmits a scheduling request (SR) to the base station, the SR requesting an uplink grant for a measurement report for the positioning measurements, receives the uplink grant from the base station in response to the SR, the uplink grant indicating uplink resources on which to transmit the measurement report, and transmits at least a portion of the measurement report to the base station on the uplink resources indicated by the uplink grant.

### CROSS-REFERENCE TO RELATED APPLICATIONS

The present Application for Patent claims the benefit of GR application Ser. No. 20/210,100650, entitled “SCHEDULING REQUEST DESIGN FOR POSITIONING REFERENCE SIGNAL (PRS) MEASUREMENT REPORTS”, filed Sep. 30, 2021, and is a national stage application, filed under 35 U.S.C. § 371, of International Patent Application No. PCT/US2022/074454, entitled, “SCHEDULING REQUEST DESIGN FOR POSITIONING REFERENCE SIGNAL (PRS) MEASUREMENT REPORTS”, filed Aug. 3, 2022, both of which are assigned to the assignee hereof and are expressly incorporated herein by reference in their entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless positioning performed by a user equipment (UE) includes receiving, from a location server, a positioning reference signal (PRS) configuration indicating one or more PRS resources to be measured by the UE during a positioning session; transmitting, to a base station serving the UE, measurement report payload related information based on the PRS configuration; and obtaining positioning measurements of the one or more PRS resources based on the PRS configuration.

In an aspect, a method of wireless positioning performed by a base station includes forwarding, from a location server to a user equipment (UE), a positioning reference signal (PRS) configuration indicating one or more PRS resources to be measured by the UE during a positioning session between the UE and the location server; and receiving measurement report payload related information for the UE for the positioning session.

In an aspect, a method of wireless positioning performed by a user equipment (UE) includes receiving, from a location server, a positioning reference signal (PRS) configuration indicating one or more PRS resources to be measured by the UE during a positioning session; obtaining positioning measurements of the one or more PRS resources based on the PRS configuration; transmitting, to a base station, a scheduling request (SR) for a first uplink grant for at least a first portion of a measurement report for the positioning measurements; receiving the first uplink grant from the base station in response to the SR, the first uplink grant indicating first uplink resources on which to transmit the first portion of the measurement report; and transmitting the first portion of the measurement report on the first uplink resources indicated by the first uplink grant, wherein the first portion of the measurement report is transmitted as a first complete Long-Term Evolution (LTE) positioning protocol (LPP) message to enable the location server to begin processing the first portion of the measurement report before reception of a second portion of the measurement report.

In an aspect, a method of positioning performed by a location server includes transmitting, to a user equipment (UE), a positioning reference signal (PRS) configuration indicating one or more PRS resources to be measured by the UE during a positioning session; transmitting, to a base station serving the UE, measurement report payload related information based on the PRS configuration; and receiving, from the UE via the base station, at least a portion of a measurement report, the at least the portion of the measurement report including positioning measurements of the one or more PRS resources.

In an aspect, a user equipment (UE) includes a memory; at least one transceiver; and at least one processor communicatively coupled to the memory and the at least one transceiver, the at least one processor configured to: receive, via the at least one transceiver, from a location server, a positioning reference signal (PRS) configuration indicating one or more PRS resources to be measured by the UE during a positioning session; transmit, via the at least one transceiver, to a base station serving the UE, measurement report payload related information based on the PRS configuration; and obtain positioning measurements of the one or more PRS resources based on the PRS configuration.

In an aspect, a base station includes a memory; at least one transceiver; and at least one processor communicatively coupled to the memory and the at least one transceiver, the at least one processor configured to: forward, from a location server to a user equipment (UE), a positioning reference signal (PRS) configuration indicating one or more PRS resources to be measured by the UE during a positioning session between the UE and the location server; and receive, via the at least one transceiver, measurement report payload related information for the UE for the positioning session.

In an aspect, an UE includes a memory; at least one transceiver; and at least one processor communicatively coupled to the memory and the at least one transceiver, the at least one processor configured to: receive, via the at least one transceiver, from a location server, a positioning reference signal (PRS) configuration indicating one or more PRS resources to be measured by the UE during a positioning session; obtain positioning measurements of the one or more PRS resources based on the PRS configuration; transmit, via the at least one transceiver, to a base station, a scheduling request (SR) for a first uplink grant for at least a first portion of a measurement report for the positioning measurements; receive, via the at least one transceiver, the first uplink grant from the base station in response to the SR, the first uplink grant indicating first uplink resources on which to transmit the first portion of the measurement report; and transmit, via the at least one transceiver, the first portion of the measurement report on the first uplink resources indicated by the first uplink grant, wherein the first portion of the measurement report is transmitted as a first complete Long-Term Evolution (LTE) positioning protocol (LPP) message to enable the location server to begin processing the first portion of the measurement report before reception of a second portion of the measurement report.

In an aspect, a location server includes a memory; at least one transceiver; and at least one processor communicatively coupled to the memory and the at least one transceiver, the at least one processor configured to: transmit, via the at least one transceiver, to a user equipment (UE), a positioning reference signal (PRS) configuration indicating one or more PRS resources to be measured by the UE during a positioning session; transmit, via the at least one transceiver, to a base station serving the UE, measurement report payload related information based on the PRS configuration; and receive, via the at least one transceiver, from the UE via the base station, at least a portion of a measurement report, the at least the portion of the measurement report including positioning measurements of the one or more PRS resources.

In an aspect, a user equipment (UE) includes means for receiving, from a location server, a positioning reference signal (PRS) configuration indicating one or more PRS resources to be measured by the UE during a positioning session; means for transmitting, to a base station serving the UE, measurement report payload related information based on the PRS configuration; and means for obtaining positioning measurements of the one or more PRS resources based on the PRS configuration.

In an aspect, a base station includes means for forwarding, from a location server to a user equipment (UE), a positioning reference signal (PRS) configuration indicating one or more PRS resources to be measured by the UE during a positioning session between the UE and the location server; and means for receiving measurement report payload related information for the UE for the positioning session.

In an aspect, an UE includes means for receiving, from a location server, a positioning reference signal (PRS) configuration indicating one or more PRS resources to be measured by the UE during a positioning session; means for obtaining positioning measurements of the one or more PRS resources based on the PRS configuration; means for transmitting, to a base station, a scheduling request (SR) for a first uplink grant for at least a first portion of a measurement report for the positioning measurements; means for receiving the first uplink grant from the base station in response to the SR, the first uplink grant indicating first uplink resources on which to transmit the first portion of the measurement report; and means for transmitting the first portion of the measurement report on the first uplink resources indicated by the first uplink grant, wherein the first portion of the measurement report is transmitted as a first complete Long-Term Evolution (LTE) positioning protocol (LPP) message to enable the location server to begin processing the first portion of the measurement report before reception of a second portion of the measurement report.

In an aspect, a location server includes means for transmitting, to a user equipment (UE), a positioning reference signal (PRS) configuration indicating one or more PRS resources to be measured by the UE during a positioning session; means for transmitting, to a base station serving the UE, measurement report payload related information based on the PRS configuration; and means for receiving, from the UE via the base station, at least a portion of a measurement report, the at least the portion of the measurement report including positioning measurements of the one or more PRS resources.

In an aspect, a non-transitory computer-readable medium stores computer-executable instructions that, when executed by a user equipment (UE), cause the UE to: receive, from a location server, a positioning reference signal (PRS) configuration indicating one or more PRS resources to be measured by the UE during a positioning session; transmit, to a base station serving the UE, measurement report payload related information based on the PRS configuration; and obtain positioning measurements of the one or more PRS resources based on the PRS configuration.

In an aspect, a non-transitory computer-readable medium stores computer-executable instructions that, when executed by a base station, cause the base station to: forward, from a location server to a user equipment (UE), a positioning reference signal (PRS) configuration indicating one or more PRS resources to be measured by the UE during a positioning session between the UE and the location server; and receive measurement report payload related information for the UE for the positioning session.

In an aspect, a non-transitory computer-readable medium stores computer-executable instructions that, when executed by an UE, cause the UE to: receive, from a location server, a positioning reference signal (PRS) configuration indicating one or more PRS resources to be measured by the UE during a positioning session; obtain positioning measurements of the one or more PRS resources based on the PRS configuration; transmit, to a base station, a scheduling request (SR) for a first uplink grant for at least a first portion of a measurement report for the positioning measurements; receive the first uplink grant from the base station in response to the SR, the first uplink grant indicating first uplink resources on which to transmit the first portion of the measurement report; and transmit the first portion of the measurement report on the first uplink resources indicated by the first uplink grant, wherein the first portion of the measurement report is transmitted as a first complete Long-Term Evolution (LTE) positioning protocol (LPP) message to enable the location server to begin processing the first portion of the measurement report before reception of a second portion of the measurement report.

In an aspect, a non-transitory computer-readable medium stores computer-executable instructions that, when executed by a location server, cause the location server to: transmit, to a user equipment (UE), a positioning reference signal (PRS) configuration indicating one or more PRS resources to be measured by the UE during a positioning session; transmit, to a base station serving the UE, measurement report payload related information based on the PRS configuration; and receive, from the UE via the base station, at least a portion of a measurement report, the at least the portion of the measurement report including positioning measurements of the one or more PRS resources.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 illustrates examples of various positioning methods supported in New Radio (NR), according to aspects of the disclosure.

FIG. 5 illustrates an example Long-Term Evolution (LTE) positioning protocol (LPP) call flow between a UE and a location server for performing positioning operations.

FIG. 6 is a diagram illustrating an example frame structure, according to aspects of the disclosure.

FIG. 7 is a diagram of an example positioning reference signal (PRS) configuration for the PRS transmissions of a given base station, according to aspects of the disclosure.

FIG. 8A is a diagram illustrating various downlink channels within an example downlink slot, according to aspects of the disclosure.

FIG. 8B is a diagram illustrating various uplink channels within an example uplink slot, according to aspects of the disclosure.

FIG. 9 is a diagram illustrating an example of PRS measurement report latency.

FIG. 10 is a diagram illustrating additional aspects of PRS measurement report latency.

FIG. 11 illustrates scheduling request (SR)-related radio resource control (RRC) information elements (IEs) that may be signaled to a UE, according to aspects of the disclosure.

FIG. 12 is a diagram illustrating the latency reduction from using an SR to indicate the desired payload size for an uplink grant, according to aspects of the disclosure.

FIG. 13 is a diagram illustrating the latency reduction from reporting each portion of a measurement report as a self-contained LPP message, according to aspects of the disclosure.

FIGS. 14 to 17 illustrate example methods of positioning, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

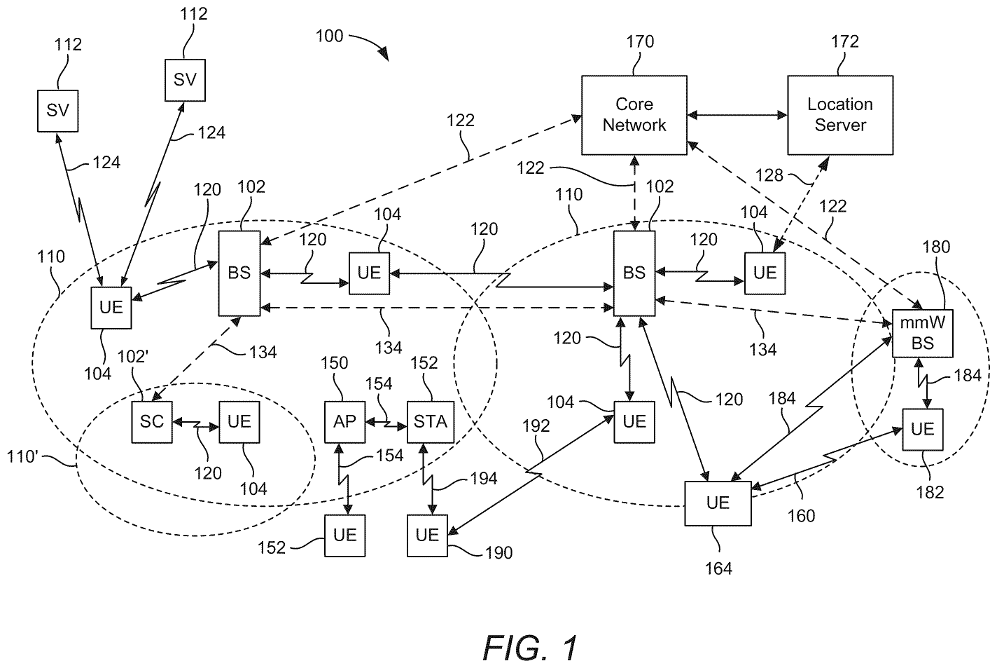

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102″, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This clement would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

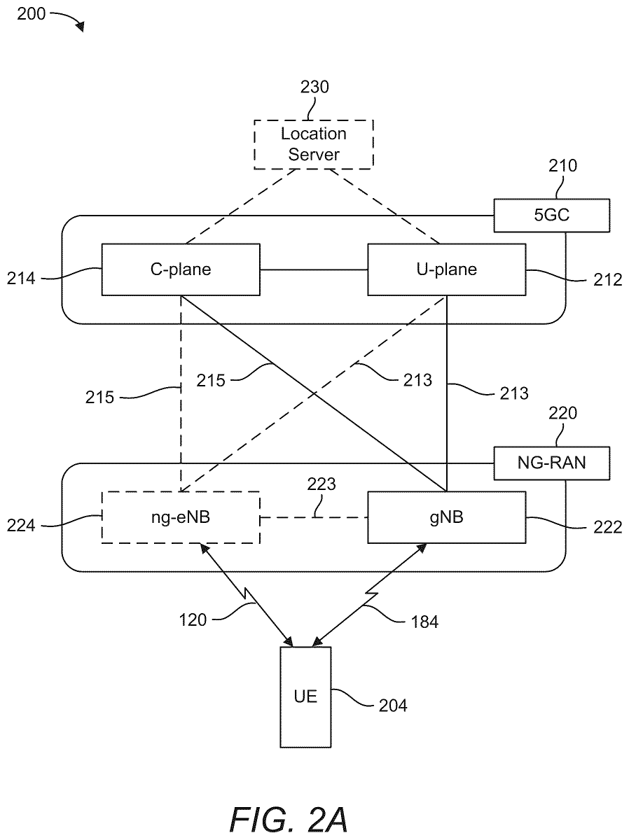

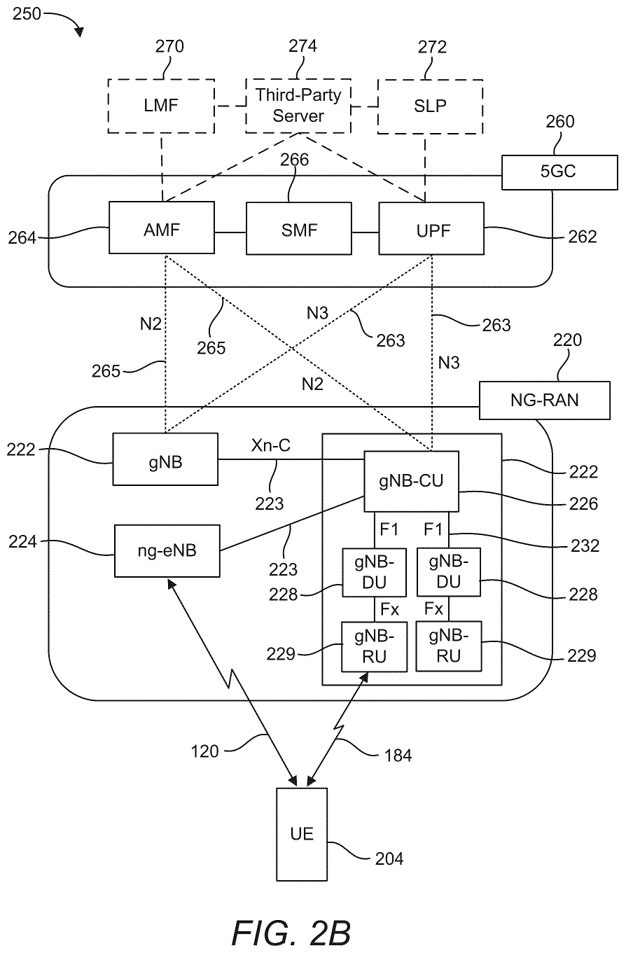

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 250. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

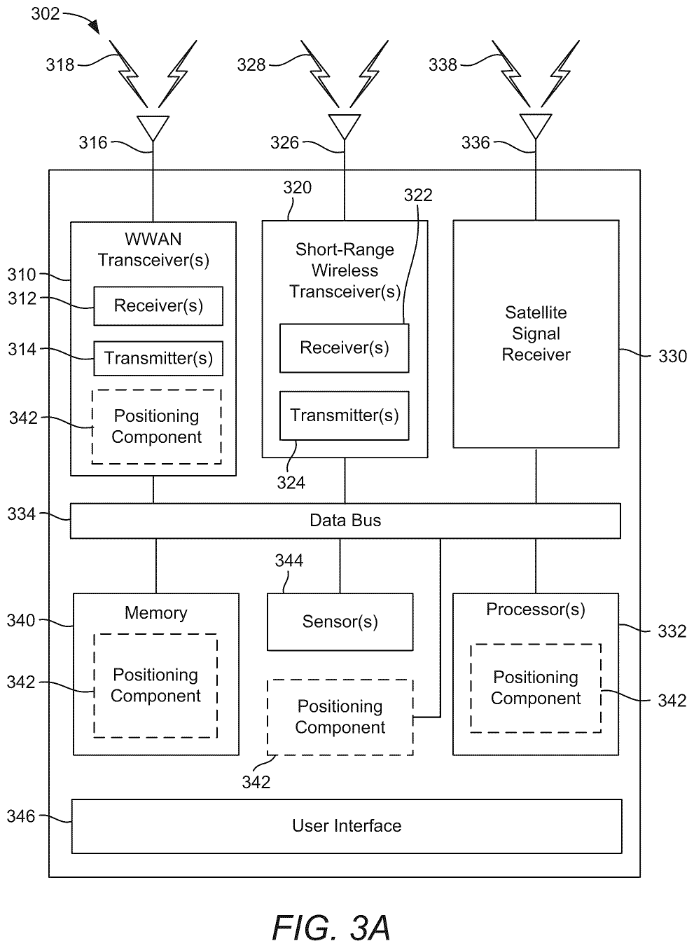

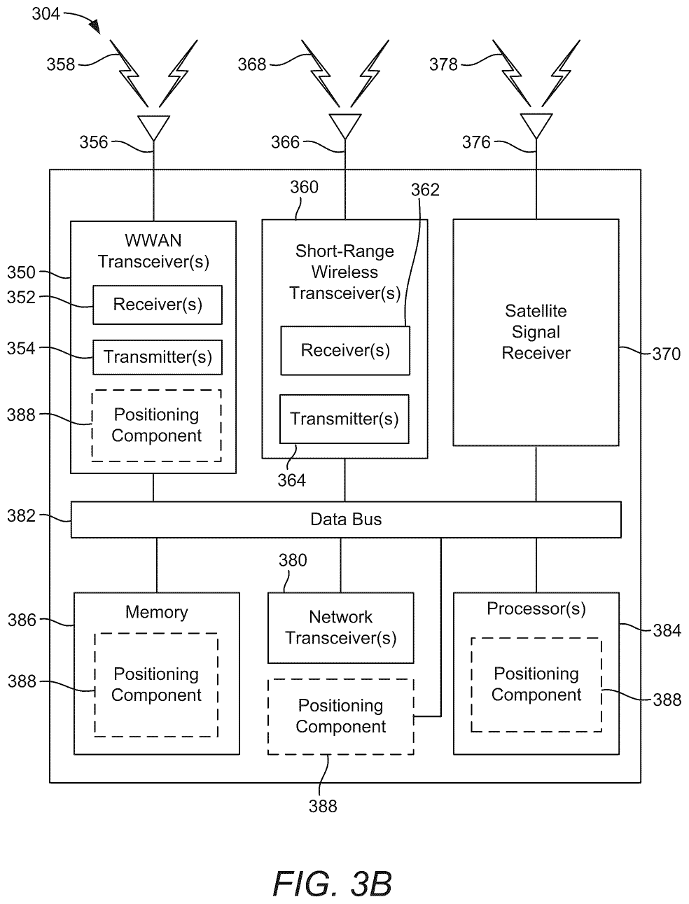

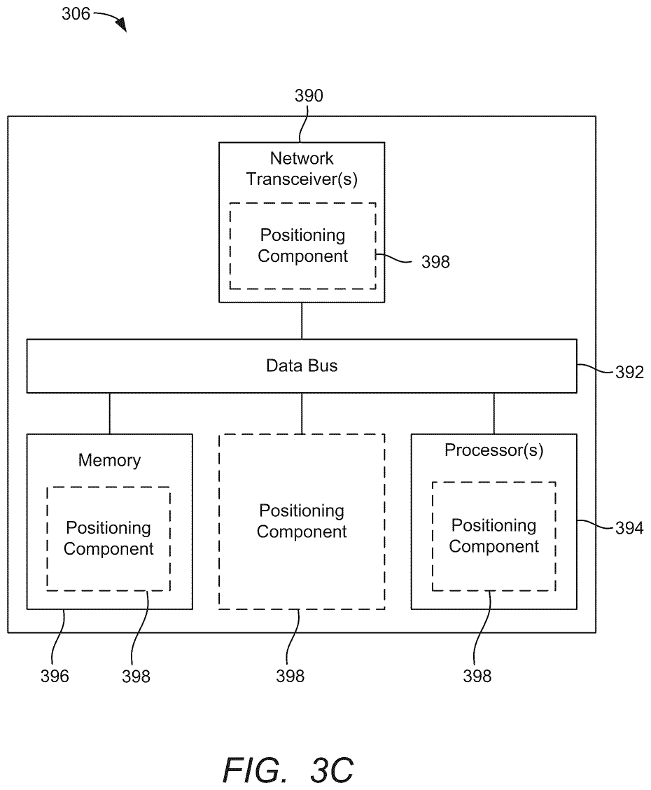

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the file transmission operations as taught herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth R), Zigbee®, Z-Wave®, PC5, dedicated short-range communications (DSRC), wireless access for vehicular environments (WAVE), near-field communication (NFC), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component 342, 388, and 398, respectively. The positioning component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the positioning component 342, 388, and 398 may be external to the processors 332, 384, and 394 (e.g., part of a modem processing system, integrated with another processing system, etc.). Alternatively, the positioning component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the positioning component 342, which may be, for example, part of the one or more WWAN transceivers 310, the memory 340, the one or more processors 332, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the uplink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the positioning component 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

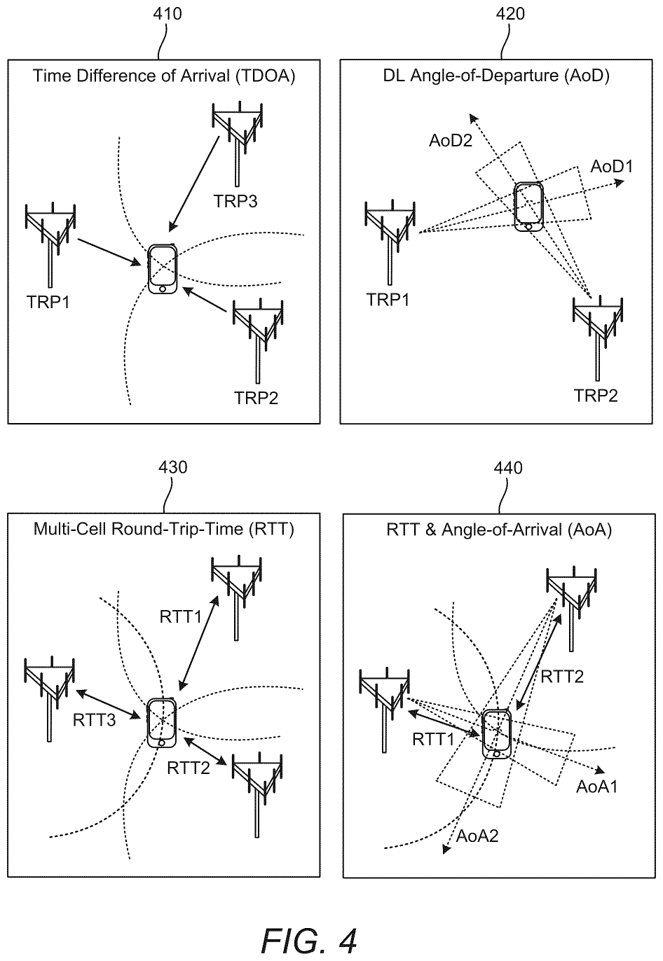

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. FIG. 4 illustrates examples of various positioning methods, according to aspects of the disclosure. In an OTDOA or DL-TDOA positioning procedure, illustrated by scenario 410, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, illustrated by scenario 420, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE. For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, illustrated by scenario 430, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy, as illustrated by scenario 440.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

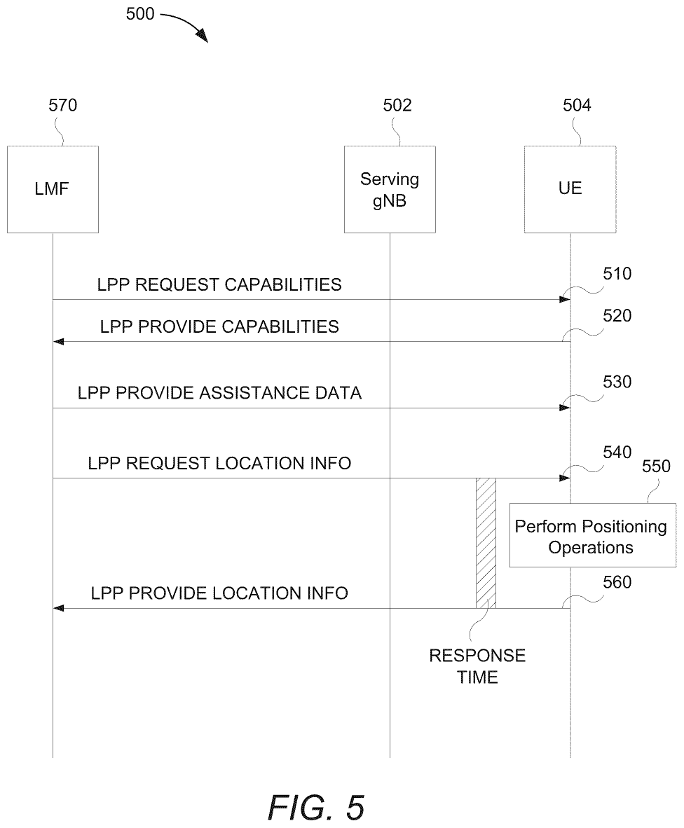

FIG. 5 illustrates an example Long-Term Evolution (LTE) positioning protocol (LPP) procedure 500 between a UE 504 and a location server (illustrated as a location management function (LMF) 570) for performing positioning operations. As illustrated in FIG. 5, positioning of the UE 504 is supported via an exchange of LPP messages between the UE 504 and the LMF 570. The LPP messages may be exchanged between UE 504 and the LMF 570 via the UE's 504 serving base station (illustrated as a serving gNB 502) and a core network (not shown). The LPP procedure 500 may be used to position the UE 504 in order to support various location-related services, such as navigation for UE 504 (or for the user of UE 504), or for routing, or for provision of an accurate location to a public safety answering point (PSAP) in association with an emergency call from UE 504 to a PSAP, or for some other reason. The LPP procedure 500 may also be referred to as a positioning session, and there may be multiple positioning sessions for different types of positioning methods (e.g., downlink time difference of arrival (DL-TDOA), round-trip-time (RTT), enhanced cell identity (E-CID), etc.)

Initially, the UE 504 may receive a request for its positioning capabilities from the LMF 570 at stage 510 (e.g., an LPP Request Capabilities message). At stage 520, the UE 504 provides its positioning capabilities to the LMF 570 relative to the LPP protocol by sending an LPP Provide Capabilities message to LMF 570 indicating the position methods and features of these position methods that are supported by the UE 504 using LPP. The capabilities indicated in the LPP Provide Capabilities message may, in some aspects, indicate the type of positioning the UE 504 supports (e.g., DL-TDOA, RTT, E-CID, etc.) and may indicate the capabilities of the UE 504 to support those types of positioning.

Upon reception of the LPP Provide Capabilities message, at stage 520, the LMF 570 determines to use a particular type of positioning method (e.g., DL-TDOA, RTT, E-CID, etc.) based on the indicated type(s) of positioning the UE 504 supports and determines a set of one or more transmission-reception points (TRPs) from which the UE 504 is to measure downlink positioning reference signals or towards which the UE 504 is to transmit uplink positioning reference signals. At stage 530, the LMF 570 sends an LPP Provide Assistance Data message to the UE 504 identifying the set of TRPs.

In some implementations, the LPP Provide Assistance Data message at stage 530 may be sent by the LMF 570 to the UE 504 in response to an LPP Request Assistance Data message sent by the UE 504 to the LMF 570 (not shown in FIG. 5). An LPP Request Assistance Data message may include an identifier of the UE's 504 serving TRP and a request for the positioning reference signal (PRS) configuration of neighboring TRPs.

At stage 540, the LMF 570 sends a request for location information to the UE 504. The request may be an LPP Request Location Information message. This message usually includes information elements defining the location information type, desired accuracy of the location estimate, and response time (i.e., desired latency). Note that a low latency requirement allows for a longer response time while a high latency requirement requires a shorter response time. However, a long response time is referred to as high latency and a short response time is referred to as low latency.

Note that in some implementations, the LPP Provide Assistance Data message sent at stage 530 may be sent after the LPP Request Location Information message at 540 if, for example, the UE 504 sends a request for assistance data to LMF 570 (e.g., in an LPP Request Assistance Data message, not shown in FIG. 5) after receiving the request for location information at stage 540.

At stage 550, the UE 504 utilizes the assistance information received at stage 530 and any additional data (e.g., a desired location accuracy or a maximum response time) received at stage 540 to perform positioning operations (e.g., measurements of DL-PRS, transmission of UL-PRS, etc.) for the selected positioning method.

At stage 560, the UE 504 may send an LPP Provide Location Information message to the LMF 570 conveying the results of any measurements that were obtained at stage 550 (e.g., time of arrival (ToA), reference signal time difference (RSTD), reception-to-transmission (Rx-Tx), etc.) and before or when any maximum response time has expired (e.g., a maximum response time provided by the LMF 570 at stage 540). The LPP Provide Location Information message at stage 560 may also include the time (or times) at which the positioning measurements were obtained and the identity of the TRP(s) from which the positioning measurements were obtained. Note that the time between the request for location information at 540 and the response at 560 is the “response time” and indicates the latency of the positioning session.

The LMF 570 computes an estimated location of the UE 504 using the appropriate positioning techniques (e.g., DL-TDOA, RTT, E-CID, etc.) based, at least in part, on measurements received in the LPP Provide Location Information message at stage 560.

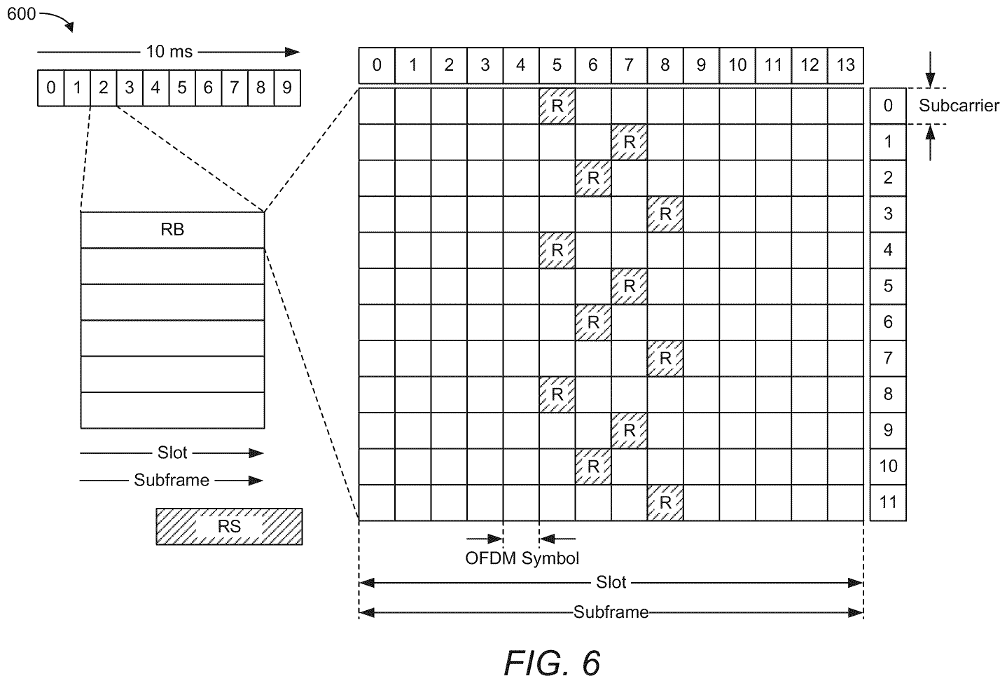

Various frame structures may be used to support downlink and uplink transmissions between network nodes (e.g., base stations and UEs). FIG. 6 is a diagram 600 illustrating an example frame structure, according to aspects of the disclosure. The frame structure may be a downlink or uplink frame structure. Other wireless communications technologies may have different frame structures and/or different channels.

LTE, and in some cases NR, utilizes OFDM on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal FFT size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 6, a numerology of 15 kHz is used. Thus, in the time domain, a 10 ms frame is divided into 10 equally sized subframes of 1 ms each, and each subframe includes one time slot. In FIG. 6, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 6, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 6 illustrates example locations of REs carrying a reference signal (labeled “R”).

A collection of resource elements (REs) that are used for transmission of PRS is referred to as a “PRS resource.” The collection of resource elements can span multiple PRBs in the frequency domain and ‘N’ (such as 1 or more) consecutive symbol(s) within a slot in the time domain. In a given OFDM symbol in the time domain, a PRS resource occupies consecutive PRBs in the frequency domain.

The transmission of a PRS resource within a given PRB has a particular comb size (also referred to as the “comb density”). A comb size ‘N’ represents the subcarrier spacing (or frequency/tone spacing) within each symbol of a PRS resource configuration. Specifically, for a comb size ‘N,’ PRS are transmitted in every Nth subcarrier of a symbol of a PRB. For example, for comb-4, for each symbol of the PRS resource configuration, REs corresponding to every fourth subcarrier (such as subcarriers 0, 4, 8) are used to transmit PRS of the PRS resource. Currently, comb sizes of comb-2, comb-4, comb-6, and comb-12 are supported for DL-PRS. FIG. 6 illustrates an example PRS resource configuration for comb-4 (which spans four symbols). That is, the locations of the shaded REs (labeled “R”) indicate a comb-4 PRS resource configuration.

Currently, a DL-PRS resource may span 2, 4, 6, or 12 consecutive symbols within a slot with a fully frequency-domain staggered pattern. A DL-PRS resource can be configured in any higher layer configured downlink or flexible (FL) symbol of a slot. There may be a constant energy per resource element (EPRE) for all REs of a given DL-PRS resource. The following are the frequency offsets from symbol to symbol for comb sizes 2, 4, 6, and 12 over 2, 4, 6, and 12 symbols. 2-symbol comb-2: {0, 1}; 4-symbol comb-2: {0, 1, 0, 1}; 6-symbol comb-2: {0, 1, 0, 1, 0, 1}; 12-symbol comb-2: {0, 1, 0, 1, 0, 1, 0, 1, 0, 1, 0, 1}; 4-symbol comb-4: {0, 2, 1, 3} (as in the example of FIG. 6); 12-symbol comb-4: {0, 2, 1, 3, 0, 2, 1, 3, 0, 2, 1, 3}; 6-symbol comb-6: {0, 3, 1, 4, 2, 5}; 12-symbol comb-6: {0, 3, 1, 4, 2, 5, 0, 3, 1, 4, 2, 5}; and 12-symbol comb-12: {0, 6, 3, 9, 1, 7, 4, 10, 2, 8, 5, 11}.

A “PRS resource set” is a set of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a TRP ID). In addition, the PRS resources in a PRS resource set have the same periodicity, a common muting pattern configuration, and the same repetition factor (such as “PRS-ResourceRepetitionFactor”) across slots. The periodicity is the time from the first repetition of the first PRS resource of a first PRS instance to the same first repetition of the same first PRS resource of the next PRS instance. The periodicity may have a length selected from 2^u*{4, 5, 8, 10, 16, 20, 32, 40, 64, 80, 160, 320, 640, 1280, 2560, 5120, 10240} slots, with μ=0, 1, 2, 3. The repetition factor may have a length selected from {1, 2, 4, 6, 8, 16, 32} slots.

A PRS resource ID in a PRS resource set is associated with a single beam (or beam ID) transmitted from a single TRP (where a TRP may transmit one or more beams). That is, each PRS resource of a PRS resource set may be transmitted on a different beam, and as such, a “PRS resource,” or simply “resource,” also can be referred to as a “beam.” Note that this does not have any implications on whether the TRPs and the beams on which PRS are transmitted are known to the UE.

A “PRS instance” or “PRS occasion” is one instance of a periodically repeated time window (such as a group of one or more consecutive slots) where PRS are expected to be transmitted. A PRS occasion also may be referred to as a “PRS positioning occasion,” a “PRS positioning instance, a “positioning occasion,” “a positioning instance,” a “positioning repetition,” or simply an “occasion,” an “instance,” or a “repetition.”

A “positioning frequency layer” (also referred to simply as a “frequency layer”) is a collection of one or more PRS resource sets across one or more TRPs that have the same values for certain parameters. Specifically, the collection of PRS resource sets has the same subcarrier spacing and cyclic prefix (CP) type (meaning all numerologies supported for the physical downlink shared channel (PDSCH) are also supported for PRS), the same Point A, the same value of the downlink PRS bandwidth, the same start PRB (and center frequency), and the same comb-size. The Point A parameter takes the value of the parameter “ARFCN-ValueNR” (where “ARFCN” stands for “absolute radio-frequency channel number”) and is an identifier/code that specifies a pair of physical radio channel used for transmission and reception. The downlink PRS bandwidth may have a granularity of four PRBs, with a minimum of 24 PRBs and a maximum of 272 PRBs. Currently, up to four frequency layers have been defined, and up to two PRS resource sets may be configured per TRP per frequency layer.

The concept of a frequency layer is somewhat like the concept of component carriers and bandwidth parts (BWPs), but different in that component carriers and BWPs are used by one base station (or a macro cell base station and a small cell base station) to transmit data channels, while frequency layers are used by several (usually three or more) base stations to transmit PRS. A UE may indicate the number of frequency layers it can support when it sends the network its positioning capabilities, such as during an LTE positioning protocol (LPP) session. For example, a UE may indicate whether it can support one or four positioning frequency layers.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. If needed to further distinguish the type of PRS, a downlink positioning reference signal may be referred to as a “DL-PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

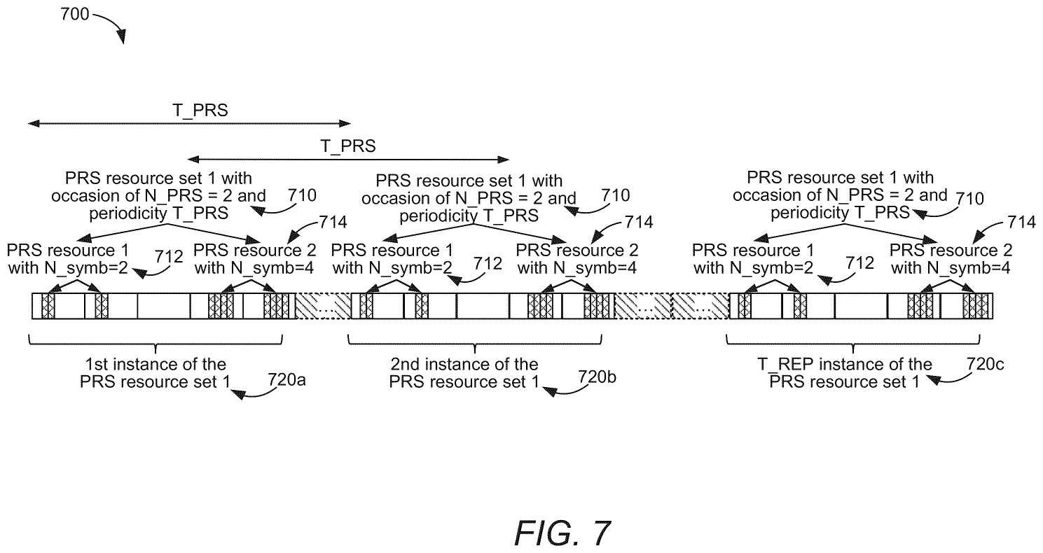

FIG. 7 is a diagram of an example PRS configuration 700 for the PRS transmissions of a given base station, according to aspects of the disclosure. In FIG. 7, time is represented horizontally, increasing from left to right. Each long rectangle represents a slot and each short (shaded) rectangle represents an OFDM symbol. In the example of FIG. 7, a PRS resource set 710 (labeled “PRS resource set 1”) includes two PRS resources, a first PRS resource 712 (labeled “PRS resource 1”) and a second PRS resource 714 (labeled “PRS resource 2”). The base station transmits PRS on the PRS resources 712 and 714 of the PRS resource set 710.

The PRS resource set 710 has an occasion length (N_PRS) of two slots and a periodicity (T_PRS) of, for example, 160 slots or 160 milliseconds (ms) (for 15 kHz subcarrier spacing). As such, both the PRS resources 712 and 714 are two consecutive slots in length and repeat every T_PRS slots, starting from the slot in which the first symbol of the respective PRS resource occurs. In the example of FIG. 7, the PRS resource 712 has a symbol length (N_symb) of two symbols, and the PRS resource 714 has a symbol length (N_symb) of four symbols. The PRS resource 712 and the PRS resource 714 may be transmitted on separate beams of the same base station.

Each instance of the PRS resource set 710, illustrated as instances 720a, 720b, and 720c, includes an occasion of length ‘2’ (i.e., N_PRS=2) for each PRS resource 712, 714 of the PRS resource set. The PRS resources 712 and 714 are repeated every T_PRS slots up to the muting sequence periodicity T_REP. As such, a bitmap of length T_REP would be needed to indicate which occasions of instances 720a, 720b, and 720c of PRS resource set 710 are muted (i.e., not transmitted).

In an aspect, there may be additional constraints on the PRS configuration 700. For example, for all PRS resources (e.g., PRS resources 712, 714) of a PRS resource set (e.g., PRS resource set 710), the base station can configure the following parameters to be the same: (a) the occasion length (N_PRS), (b) the number of symbols (N_symb), (c) the comb type, and/or (d) the bandwidth. In addition, for all PRS resources of all PRS resource sets, the subcarrier spacing and the cyclic prefix can be configured to be the same for one base station or for all base stations. Whether it is for one base station or all base stations may depend on the UE's capability to support the first and/or second option.

A location server (e.g., LMF 270) may provide assistance data to a UE (e.g., in an LPP Provide Assistance Data as at stage 530) that indicates the PRS configuration 700 for one or more base stations (or TRPs).

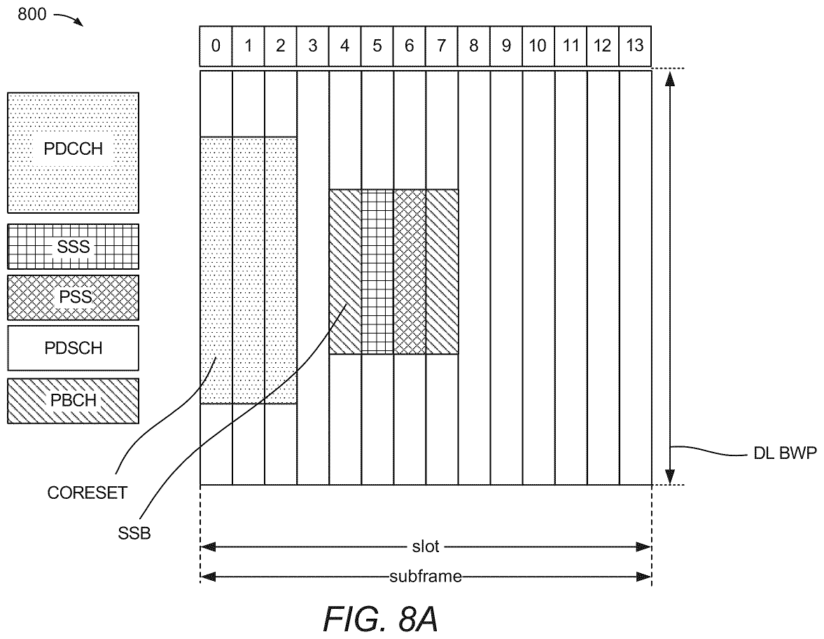

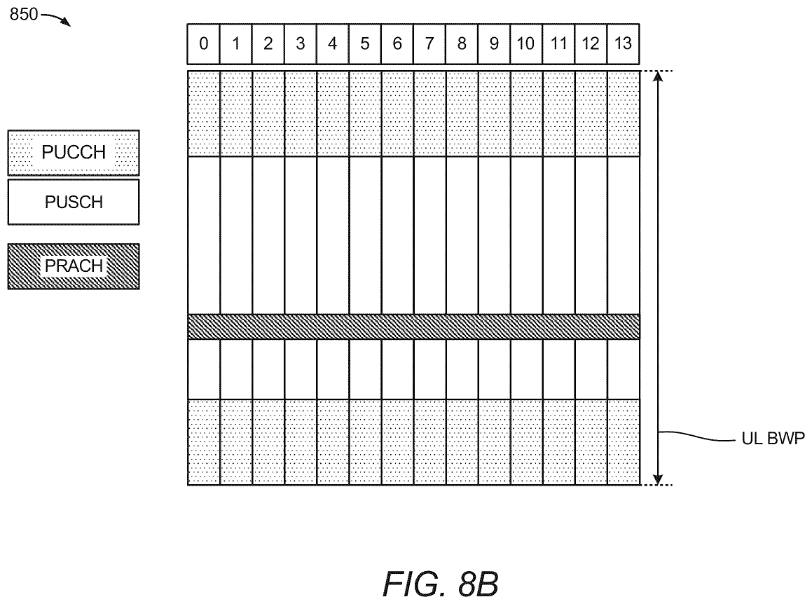

FIG. 8A is a diagram 800 illustrating various downlink channels within an example downlink slot. In FIG. 8A, time is represented horizontally (on the X axis) with time increasing from left to right, while frequency is represented vertically (on the Y axis) with frequency increasing (or decreasing) from bottom to top. In the example of FIG. 8A, a numerology of 15 kHz is used. Thus, in the time domain, the illustrated slot is one millisecond (ms) in length, divided into 14 symbols.

In NR, the channel bandwidth, or system bandwidth, is divided into multiple bandwidth parts (BWPs). A BWP is a contiguous set of RBs selected from a contiguous subset of the common RBs for a given numerology on a given carrier. Generally, a maximum of four BWPs can be specified in the downlink and uplink. That is, a UE can be configured with up to four BWPs on the downlink, and up to four BWPs on the uplink. Only one BWP (uplink or downlink) may be active at a given time, meaning the UE may only receive or transmit over one BWP at a time. On the downlink, the bandwidth of each BWP should be equal to or greater than the bandwidth of the SSB, but it may or may not contain the SSB.

Referring to FIG. 8A, a primary synchronization signal (PSS) is used by a UE to determine subframe/symbol timing and a physical layer identity. A secondary synchronization signal (SSS) is used by a UE to determine a physical layer cell identity group number and radio frame timing. Based on the physical layer identity and the physical layer cell identity group number, the UE can determine a PCI. Based on the PCI, the UE can determine the locations of the aforementioned DL-RS. The physical broadcast channel (PBCH), which carries a master information block (MIB), may be logically grouped with the PSS and SSS to form an SSB (also referred to as an SS/PBCH). The MIB provides a number of RBs in the downlink system bandwidth and a system frame number (SFN). The physical downlink shared channel (PDSCH) carries user data, broadcast system information not transmitted through the PBCH, such as system information blocks (SIBs), and paging messages.

The physical downlink control channel (PDCCH) carries downlink control information (DCI) within one or more control channel elements (CCEs), each CCE including one or more RE group (REG) bundles (which may span multiple symbols in the time domain), each REG bundle including one or more REGs, each REG corresponding to 12 resource elements (one resource block) in the frequency domain and one OFDM symbol in the time domain. The set of physical resources used to carry the PDCCH/DCI is referred to in NR as the control resource set (CORESET). In NR, a PDCCH is confined to a single CORESET and is transmitted with its own DMRS. This enables UE-specific beamforming for the PDCCH.

In the example of FIG. 8A, there is one CORESET per BWP, and the CORESET spans three symbols (although it may be only one or two symbols) in the time domain. Unlike LTE control channels, which occupy the entire system bandwidth, in NR, PDCCH channels are localized to a specific region in the frequency domain (i.e., a CORESET). Thus, the frequency component of the PDCCH shown in FIG. 8A is illustrated as less than a single BWP in the frequency domain. Note that although the illustrated CORESET is contiguous in the frequency domain, it need not be. In addition, the CORESET may span less than three symbols in the time domain.

The DCI within the PDCCH carries information about uplink resource allocation (persistent and non-persistent) and descriptions about downlink data transmitted to the UE, referred to as uplink and downlink grants, respectively. More specifically, the DCI indicates the resources scheduled for the downlink data channel (e.g., PDSCH) and the uplink data channel (e.g., physical uplink shared channel (PUSCH)). Multiple (e.g., up to eight) DCIs can be configured in the PDCCH, and these DCIs can have one of multiple formats. For example, there are different DCI formats for uplink scheduling, for downlink scheduling, for uplink transmit power control (TPC), etc. A PDCCH may be transported by 1, 2, 4, 8, or 16 CCEs in order to accommodate different DCI payload sizes or coding rates.

The following are the currently supported DCI formats. Format 0-0: fallback for scheduling of PUSCH; Format 0-1: non-fallback for scheduling of PUSCH; Format 1-0: fallback for scheduling of PDSCH; Format 1-1: non-fallback for scheduling of PDSCH; Format 2-0: notifying a group of UEs of the slot format; Format 2-1: notifying a group of UEs of the PRB(s) and OFDM symbol(s) where the UEs may assume no transmissions are intended for the UEs; Format 2-2: transmission of TPC commands for PUCCH and PUSCH; and Format 2-3: transmission of a group of SRS requests and TPC commands for SRS transmissions. Note that a fallback format is a default scheduling option that has non-configurable fields and supports basic NR operations. In contrast, a non-fallback format is flexible to accommodate NR features.

As will be appreciated, a UE needs to be able to demodulate (also referred to as “decode”) the PDCCH in order to read the DCI, and thereby to obtain the scheduling of resources allocated to the UE on the PDSCH and PUSCH. If the UE fails to demodulate the PDCCH, then the UE will not know the locations of the PDSCH resources and it will keep attempting to demodulate the PDCCH using a different set of PDCCH candidates in subsequent PDCCH monitoring occasions. If the UE fails to demodulate the PDCCH after some number of attempts, the UE declares a radio link failure (RLF). To overcome PDCCH demodulation issues, search spaces are configured for efficient PDCCH detection and demodulation.

Generally, a UE does not attempt to demodulate each and very PDCCH candidate that may be scheduled in a slot. To reduce restrictions on the PDCCH scheduler, and at the same time to reduce the number of blind demodulation attempts by the UE, search spaces are configured. Search spaces are indicated by a set of contiguous CCEs that the UE is supposed to monitor for scheduling assignments/grants relating to a certain component carrier. There are two types of search spaces used for the PDCCH to control each component carrier, a common search space (CSS) and a UE-specific search space (USS).

A common search space is shared across all UEs, and a UE-specific search space is used per UE (i.e., a UE-specific search space is specific to a specific UE). For a common search space, a DCI cyclic redundancy check (CRC) is scrambled with a system information radio network temporary identifier (SI-RNTI), random access RNTI (RA-RNTI), temporary cell RNTI (TC-RNTI), paging RNTI (P-RNTI), interruption RNTI (INT-RNTI), slot format indication RNTI (SFI-RNTI), TPC-PUCCH-RNTI, TPC-PUSCH-RNTI, TPC-SRS-RNTI, cell RNTI (C-RNTI), or configured scheduling RNTI (CS-RNTI) for all common procedures. For a UE-specific search space, a DCI CRC is scrambled with a C-RNTI or CS-RNTI, as these are specifically targeted to individual UE.

A UE demodulates the PDCCH using the four UE-specific search space aggregation levels (1, 2, 4, and 8) and the two common search space aggregation levels (4 and 8). Specifically, for the UE-specific search spaces, aggregation level ‘1’ has six PDCCH candidates per slot and a size of six CCEs. Aggregation level ‘2’ has six PDCCH candidates per slot and a size of 12 CCEs. Aggregation level ‘4’ has two PDCCH candidates per slot and a size of eight CCEs. Aggregation level ‘8’ has two PDCCH candidates per slot and a size of 16 CCEs. For the common search spaces, aggregation level ‘4’ has four PDCCH candidates per slot and a size of 16 CCEs. Aggregation level ‘8’ has two PDCCH candidates per slot and a size of 16 CCEs.

Each search space comprises a group of consecutive CCEs that could be allocated to a PDCCH, referred to as a PDCCH candidate. A UE demodulates all of the PDCCH candidates in these two search spaces (USS and CSS) to discover the DCI for that UE. For example, the UE may demodulate the DCI to obtain the scheduled uplink grant information on the PUSCH and the downlink resources on the PDSCH. Note that the aggregation level is the number of REs of a CORESET that carry a PDCCH DCI message, and is expressed in terms of CCEs. There is a one-to-one mapping between the aggregation level and the number of CCEs per aggregation level. That is, for aggregation level ‘4,’ there are four CCEs. Thus, as shown above, if the aggregation level is ‘4’ and the number of PDCCH candidates in a slot is ‘2,’ then the size of the search space is ‘8’ (i.e., 4×2=8).

FIG. 8B is a diagram 850 illustrating various uplink channels within an example uplink slot. In FIG. 8B, time is represented horizontally (on the X axis) with time increasing from left to right, while frequency is represented vertically (on the Y axis) with frequency increasing (or decreasing) from bottom to top. In the example of FIG. 8B, a numerology of 15 kHz is used. Thus, in the time domain, the illustrated slot is one millisecond (ms) in length, divided into 14 symbols.

A random-access channel (RACH), also referred to as a physical random-access channel (PRACH), may be within one or more slots within a frame based on the PRACH configuration. The PRACH may include six consecutive RB pairs within a slot. The PRACH allows the UE to perform initial system access and achieve uplink synchronization. A physical uplink control channel (PUCCH) may be located on edges of the uplink system bandwidth. The PUCCH carries uplink control information (UCI), such as scheduling requests (SRs), CSI reports, a channel quality indicator (CQI), a precoding matrix indicator (PMI), a rank indicator (RI), and HARQ ACK/NACK feedback. The physical uplink shared channel (PUSCH) carries data, and may additionally be used to carry a buffer status report (BSR), a power headroom report (PHR), and/or UCI.

Although the communication speeds afforded by 5G NR have decreased the latency of positioning operations, further reductions in latency would be beneficial. For example, it would be beneficial to reduce the latency associated with the PRS measurement report (e.g., an LPP Provide Location Information message as at stage 560).

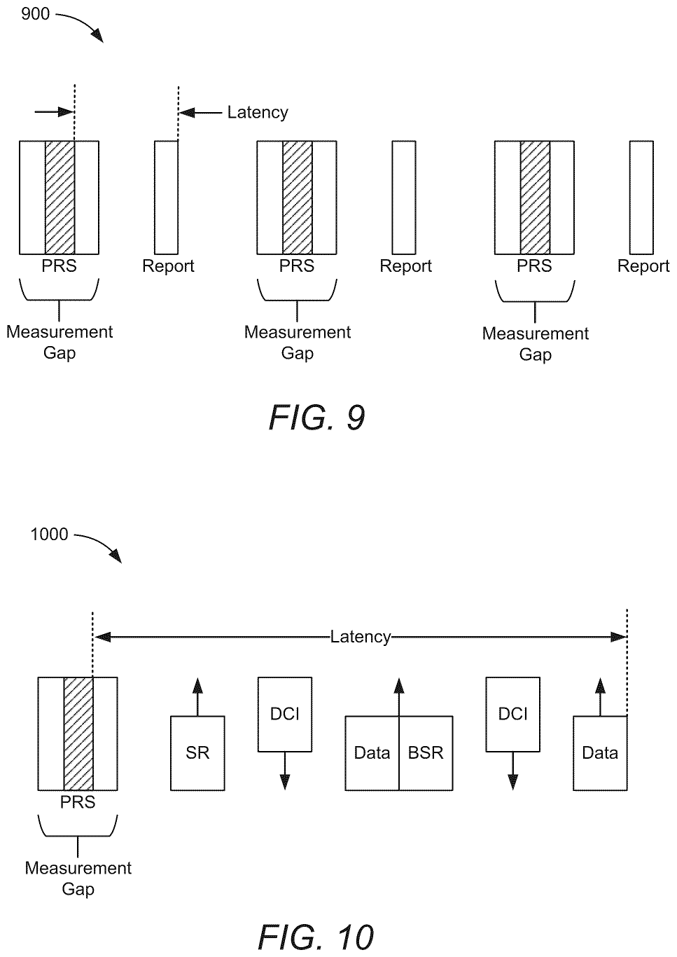

FIG. 9 is a diagram 900 illustrating an example of PRS measurement report latency. Each block in FIG. 9 represents a block of time and frequency resources (e.g., some number of PRBs in the frequency domain and some number of symbols or slots in the time domain). More specifically, FIG. 9 illustrates three measurement gaps (time periods during which a UE at least does not expect to receive any downlink data from its serving base station) and three PRS instances within those measurement gaps. Each PRS instance (e.g., an instance 720a, 720b, 720c) includes one or more PRS resources (e.g., PRS resources 712, 714) of one or more PRS resource sets (e.g., PRS resource set 710) of one or more neighboring (i.e., non-serving) TRPs. The one or more PRS resources of the PRS instance in each measurement gap may be from different TRPs, or may be repetitions of the same one or more PRS resources from the same TRP. The blocks in FIG. 9 representing the PRS instances may represent only the one or more PRS resources of the PRS instance themselves, or may represent the time it takes the UE to measure and process the one or more PRS resources to determine one or more positioning measurements of the one or more PRS resources.

Subsequently, the UE transmits a measurement report (labeled simply “Report” in FIG. 9) containing the one or more positioning measurements of the one or more PRS resources to the location server (e.g., LMF 270). The measurement and reporting illustrated in FIG. 9 is similar to that illustrated in FIG. 5 (specifically, stages 550 and 560). The primary difference is that the UE in FIG. 9 measures and reports multiple times, while FIG. 5 illustrates a single measurement and reporting cycle.

As further shown in FIG. 9, the period of time from the end of a PRS instance to the end of transmission of a measurement report is the measurement report latency (labeled simply “Latency” in FIG. 9). To reduce the measurement report latency, it has been determined that it would be beneficial to support providing assistance information to the UE's serving base station for configuration and/or scheduling of the PUSCH that carries the positioning measurement report, where the assistance information includes at least the expected time of the positioning measurement report.

Note that while FIG. 9 illustrates the use of measurement gaps, the same considerations regarding latency apply to PRS processing gaps, or windows. More specifically, a PRS processing gap is a time period, that is not a measurement gap, during which the UE prioritizes the reception and processing of PRS over the reception and processing of other downlink channels, and possibly over the transmission of uplink channels as well.

FIG. 10 is a diagram 1000 illustrating additional aspects of PRS measurement report latency. Each block in FIG. 10 represents a block of time and frequency resources (e.g., some number of PRBs in the frequency domain and some number of symbols or slots in the time domain). FIG. 10 illustrates a single measurement gap containing a single PRS instance (e.g., any of the PRS instances and associated measurement gaps in FIG. 9). After measuring and processing the PRS instance, the UE needs to transmit a scheduling request (SR) for an uplink grant of PUSCH resources on which to transmit the measurement report.

Note that a measurement report is an LPP message (e.g., an LPP Provide Location Information message as at stage 560) transmitted to the base station on the PUSCH. LPP messages are Layer-3 messages and are encapsulated within lower layer messages (e.g., RRC messages) when exchanged between the UE and the base station. As such, the base station simply forwards the measurement report to the location server—it cannot itself decode an LPP message.

In response, the UE receives DCI from its serving base station indicating an uplink grant of PUSCH resources on which to transmit at least a portion of the measurement report. Currently, a scheduling request can only request limited uplink resources, which, in general, are not sufficient to carry an entire LPP measurement report. Accordingly, the UE then transmits a portion of the measurement report (labeled “Data” in FIG. 10) on the allocated PUSCH resources, as well as a BSR (a type of MAC control element (MAC-CE)) indicating that it has more uplink data to transmit.

In response, the UE receives second DCI from its serving base station indicating an uplink grant of PUSCH resources on which to transmit a subsequent portion of the measurement report. In the example of FIG. 10, the UE then transmits the remaining portion of the measurement report on the allocated PUSCH resources. Note that while FIG. 10 illustrates the UE transmitting the measurement report in two data blocks, the UE may actually need more data blocks. In that case, the UE would continue sending BSRs with the data blocks until it had no more data to transmit.

As shown in FIG. 10, there is some amount of latency between the end of the measured PRS instance and the end of the uplink transmission of the measurement report. The present disclosure provides various techniques to reduce that latency.

As would be appreciated, if the UE's serving base station had prior knowledge of the payload size needed for a measurement report, it could configure sufficient PUSCH resources in the first DCI. Thus, at a high level, the present disclosure provides techniques for a scheduling request to include a requested uplink grant size, where the requested grant size is determined based on the configuration and/or the reporting requirements associated with the measured PRS resources.

The payload size of the uplink grant needed for an LPP measurement report can be estimated based on the PRS configuration (e.g., PRS configuration 700) provided to the UE (e.g., as in an LPP Provide Assistance Data message at stage 530). That is, based on the PRS configuration, the UE (or the location server) can estimate the number of measurements that the UE will be expected to report (e.g., as in an LPP Provide Location Information message at stage 560). Specifically, given the number of TRPs indicated in the PRS configuration, the number of PRS resource sets indicated in the PRS configuration, the number of PRS resources indicated in the PRS configuration, the muting pattern indicated in the PRS configuration, and the type of positioning method, the number of measurements to be performed and reported per PRS occasion (or instance) can be estimated. In addition, besides the PRS configuration, the outlier rejection engine (of the positioning entity) may identify a subset of measurements based on previous occasions and assign higher reporting priority to a subset of measurements in the next occasion(s). Based on the estimated number of measurements, the uplink payload for the LPP measurement report can be estimated.

Uplink grants are controlled by a UE's serving base station. However, the PRS configuration provided to the UE is currently only known to the location server and the UE (e.g., via an LPP Provide Assistance Data message as at stage 530), not the base station. Accordingly, a mechanism is needed to enable the base station to determine (or estimate) the measurement report payload and schedule the appropriate uplink resources.

The present disclosure provides techniques for either the UE and/or the location server to provide and/or update measurement report payload related information, such as the PRS configuration and/or the payload estimate, to the serving base station. In an aspect, the location server may provide a list of PRS configurations to the base station and further indicate the one configured for a specific UE. The location server may provide this information to the base station via NR positioning protocol type A (NRPPa), which is the communication protocol between base stations and location servers. The location server may alternatively or additionally send an estimate of the measurement report payload size to the base station, or the base station may derive the payload size based on the PRS configuration information.

The UE may have better real-time payload estimation information than the location server, and therefore, in various aspects, it can indicate and/or update the payload information to the base station. The UE may provide this information using UCI, one or more MAC-CEs, or one or more RRC messages. Both the UE and the location server may provide information to the base station. For example, the location server may provide the PRS configuration information and the UE may provide the payload estimate. Both may then update the base station as appropriate (e.g., when there are changes to any of the provided information).

In various aspects, where the PRS configuration is provided to the base station to enable the base station to estimate the number of measurements that will be reported, the location server or the UE may further provide outlier rejection results to the base station to update the estimated number of measurements. More specifically, outlier measurements are observed measurements of PRS resources that are outside of a tolerance threshold of the expected measurements of those PRS resources. Inlier measurements are observed measurements of PRS resources that are within the tolerance threshold. A UE does not report outlier measurements, referred to as “outlier rejection.”

In various aspects, the payload estimation may be further based on the minimum number of measurements required for the specific type of positioning method. For example, a TDOA-based positioning procedure may require a different number of measurements than an RTT positioning procedure, which may require a different number of measurements than an angle-based positioning procedure.

In various aspects, the payload estimation may be further based on the QoS requirements of the positioning session and/or the estimated location of the UE. This may be implicitly indicated by the number of PRS resources the UE is expected to measure, with more PRS resources indicating a higher QoS requirement and fewer PRS resources indicating a lower QoS requirement.

In various aspects, the SR from the UE to the base station may indicate the desired payload size for the uplink grant. An SR is a type of UCI sent by the UE for a dynamic (or on-demand) uplink grant. In response to an SR, the base station allocates uplink resources to the UE on the PUSCH.

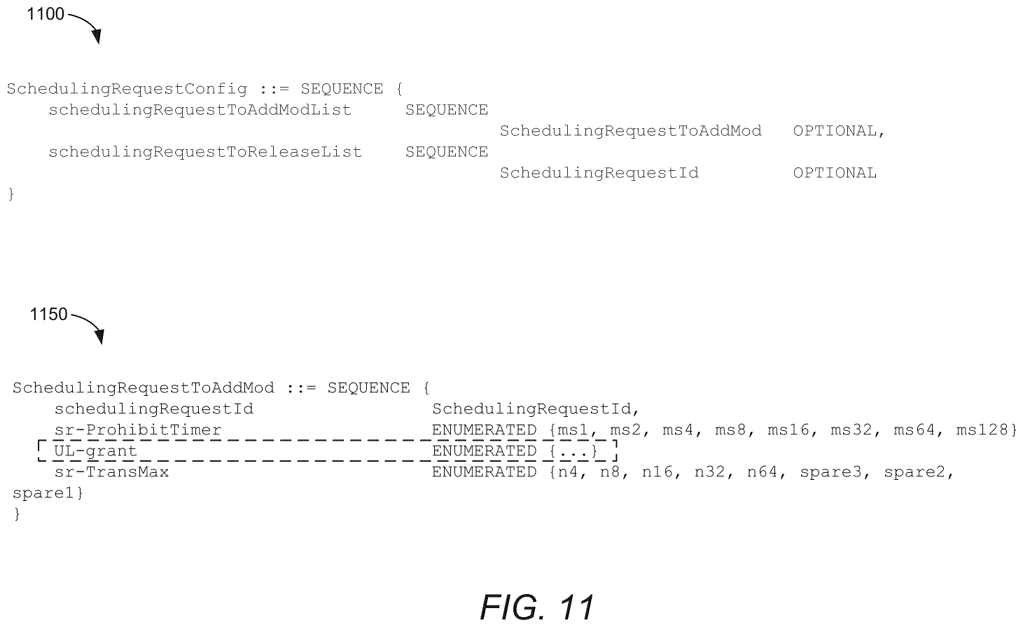

Based on the received PRS configuration and/or payload estimation (from the UE and/or the location server), the base station can determine the appropriate uplink grant size for the measurement report. The base station can then add the determined uplink grant size to a new SR configuration in the RRC signaling to the UE. For example, FIG. 11 illustrates SR-related RRC information elements (IEs) that may be signaled to a UE, according to aspects of the disclosure. Specifically, a “SchedulingRequestConfig” IE 1100 includes a “schedulingRequestToAddModList” fields that points to a sequence of “SchedulingRequestToAddMod” IEs. A “SchedulingRequestToAddMod” IE 1150 includes a “schedulingRequestId” field that includes a “Scheduling Requestld” to identify the particular SR. The “SchedulingRequestToAddMod” IE 1150 also includes an “UL-grant” field indicating the size of the uplink grant associated with that particular SR (identified by “SchedulingRequestId”). The uplink grant size (shown as an ellipse inside the bracket) may be one value or a series of values. The series of values may be for the case that the uplink payload fluctuates across PRS occasions, which may be due to the muting pattern. Although the illustrated IEs are RRC IEs, in various aspects, the IEs can be configured to the UE using DCI, MAC-CE, and/or RRC.

The base station allocates the SR occasion for an SR (i.e., the PUCCH resources on which the UE can transmit an SR) based on the measurement gap pattern and/or the PRS measurement report latency requirement. The SR occasion should be close in time to a measurement gap after which the UE will be transmitting a measurement report (e.g., as in the examples of FIGS. 9 and 10). For example, the SR occasion may be ahead of (i.e., before) the measurement gap or after the measurement gap (as in the example of FIG. 10). The SR occasion could be before the measurement gap because the UE will presumably have already estimated the number of measurements to be performed during the measurement gap and reported in the subsequent report. The SR occasion could also overlap, fully or partially, with the measurement gap.

In various aspects, the base station may also consider the UE's PRS processing capability when determining the PUCCH resource allocation. The UE's PRS processing capability may be provided to the base station by the UE or the location server. The UE's PRS processing capability indicates the number of PRS resources (e.g., in symbols or milliseconds) that the UE can process per some period of time (e.g., some number of slots or milliseconds). Lower processing capabilities may indicate that the UE will be reporting fewer measurements in the measurement report, while higher processing capabilities may indicate that the UE will be reporting more measurements in the measurement report.

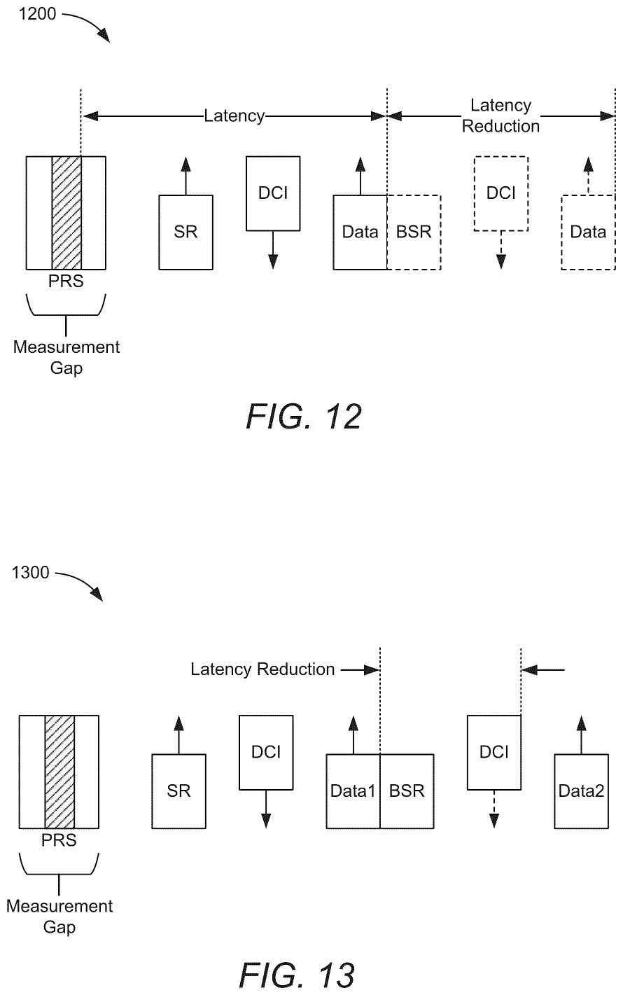

FIG. 12 is a diagram 1200 illustrating the latency reduction from using an SR to indicate the desired payload size for an uplink grant, as described above, according to aspects of the disclosure. Each block in FIG. 12 represents a block of time and frequency resources (e.g., some number of PRBs in the frequency domain and some number of symbols or slots in the time domain). FIG. 12 illustrates a single measurement gap containing a single PRS instance, which may correspond to any of the PRS instances and associated measurement gaps in FIG. 9.

After measuring and processing the PRS instance, the UE needs to transmit an SR for an uplink grant of PUSCH resources on which to transmit the measurement report. As shown in FIG. 12, the SR occasion, and therefore the SR, is after the measurement gap, but as described above, it need not be. In the example of FIG. 12, the UE transmits the SR that was allocated by the base station for reporting the measurement report for that measurement gap, as described above. Based on reception of that SR, the base station allocates (via DCI) sufficient PUSCH resources for the UE to transmit the entire measurement report in a single uplink transmission. The UE then transmits the report on the allocated PUSCH resources (illustrated as the “Data” block).

As illustrated in FIG. 12, because the UE can send an entire measurement report in one uplink grant, there is no need to transmit a BSR requesting a subsequent uplink grant, nor is there any need for the subsequent grant. As such, latency is reduced.

In some cases, the payload estimation may not be very accurate—the actual payload size may be different from the estimated size of the payload (i.e., measurement report). As a first option, the base station may configure multiple SRs, each for a different payload size. For example, a first SR may be used to request an uplink grant to report X measurements, a second SR may be used to request an uplink grant to report Y measurements, and a third SR may be used to request an uplink grant to report Z measurements. Each SR may be scheduled in a different SR occasion in the PUCCH. The UE may then select an SR occasion, and thereby the corresponding SR, based on the real-time (actual) payload size to be reported. That is, by transmitting an SR in a particular SR occasion, the SR indicates the size of the requested uplink grant. The UE should select the SR with the smallest requested uplink grant size that is greater than or equal to the payload size.

As a second option, besides the size of the measurement report, the uplink grant size may further consider the size of the BSR. If the UE has more data to report than will fit in the allocated resources (e.g., the actual measurement report is larger than the resources that were allocated based on the estimated size of the measurement report), the UE can use a BSR to request an additional uplink grant, as described above with reference to FIG. 10. Otherwise, it can use the BSR to report that there is no more data in its buffer. In this case, for each uplink data transmission, the UE should report the number of measurements permitted by the uplink grant size as one self-contained (i.e., standalone, or complete) LPP message. In that way, the location server can begin decoding the message without having to wait for the remainder of the message in a second data transmission. In various aspects, in selecting measurements for the first data transmission, the UE may prefer to report measurements based on the outlier rejection feedback from the positioning entity (whether the UE's positioning engine or the location server).

FIG. 13 is a diagram 1300 illustrating the latency reduction from reporting each portion of a measurement report as a self-contained LPP message, as described above, according to aspects of the disclosure. Each block in FIG. 13 represents a block of time and frequency resources (e.g., some number of PRBs in the frequency domain and some number of symbols or slots in the time domain). FIG. 13 illustrates a single measurement gap containing a single PRS instance, which may correspond to any of the PRS instances and associated measurement gaps in FIG. 9.

After measuring and processing the PRS instance, the UE needs to transmit an SR for an uplink grant of PUSCH resources on which to transmit the measurement report. As shown in FIG. 13, the SR occasion, and therefore the SR, is after the measurement gap, but as described above, it need not be. The SR may have been allocated by the base station based on the estimated size of the measurement report, as described above. In response, the UE receives DCI from its serving base station indicating an uplink grant of PUSCH resources on which to transmit the measurement report. However, in the example of FIG. 13, the allocated resources are not sufficient to carry the entire measurement report. This may be because, for example, the estimated size of the measurement report was smaller than the actual size of the measurement report. Accordingly, the UE transmits a first portion of the measurement report (labeled “Data1”) on the allocated PUSCH resources, as well as a BSR indicating that the UE has more uplink data to transmit. In the example of FIG. 13, the UE reports the number of measurements permitted by the uplink grant size as one self-contained LPP message.

In response to the BSR indicating that the UE has more data to send, the UE receives second DCI from its serving base station indicating an uplink grant of additional PUSCH resources on which to transmit a subsequent portion of the measurement report (labeled “Data2”). In the example of FIG. 13, the UE then transmits the remaining portion of the measurement report on the allocated PUSCH resources. Note that while FIG. 13 illustrates the UE transmitting the measurement report in two data blocks, the UE may actually need more data blocks, depending on the difference between the estimated and actual sizes of the measurement report and the size of the second uplink resource allocation. In that case, the UE would continue sending BSRs with the data blocks until it had no more data to transmit.

Because the UE transmits the Data1 block as a self-contained LPP message, the location server can immediately begin processing the measurements, rather than waiting for the remainder of the measurement report (e.g., the Data2 block). As such, as illustrated in FIG. 13, latency is reduced by the amount of the BSR and second DCI.

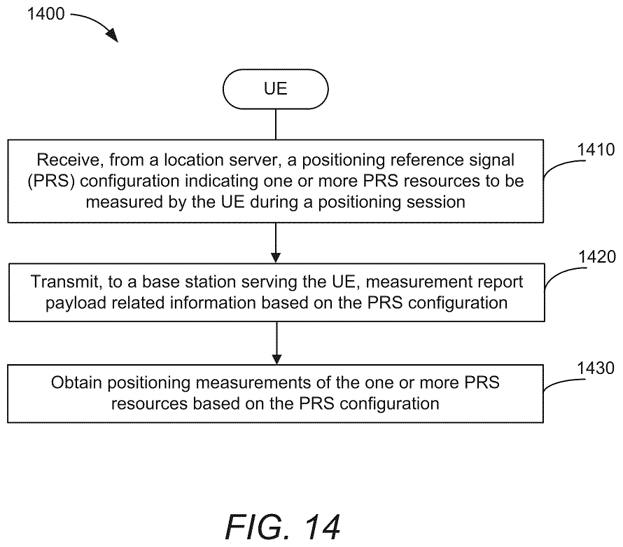

FIG. 14 illustrates an example method 1400 of wireless positioning, according to aspects of the disclosure. In an aspect, method 1400 may be performed by a UE (e.g., any of the UEs described herein).

At 1410, the UE receives, from a location server (e.g., LMF 270), a PRS configuration (e.g., PRS configuration 700) indicating one or more PRS resources to be measured by the UE during a positioning session. In an aspect, operation 1410 may be performed by the one or more WWAN transceivers 310, the one or more processors 332, memory 340, and/or positioning component 342, any or all of which may be considered means for performing this operation.

At 1420, the UE transmits, to a base station serving the UE (e.g., any of the base stations described herein), measurement report payload related information based on the PRS configuration. In an aspect, operation 1420 may be performed by the one or more WWAN transceivers 310, the one or more processors 332, memory 340, and/or positioning component 342, any or all of which may be considered means for performing this operation.

At 1430, the UE obtains positioning measurements of the one or more PRS resources based on the PRS configuration. In an aspect, operation 1430 may be performed by the one or more WWAN transceivers 310, the one or more processors 332, memory 340, and/or positioning component 342, any or all of which may be considered means for performing this operation.

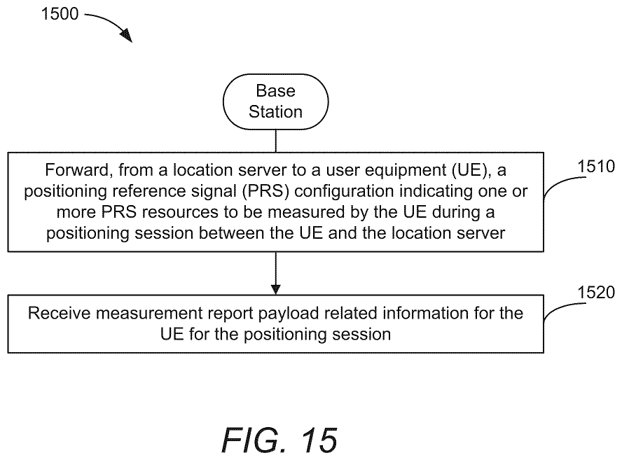

FIG. 15 illustrates an example method 1500 of wireless positioning, according to aspects of the disclosure. In an aspect, method 1500 may be performed by a base station (e.g., any of the base stations described herein).

At 1510, the base station forwards, from a location server to a UE, a PRS configuration indicating one or more PRS resources to be measured by the UE during a positioning session between the UE and the location server. In an aspect, operation 1510 may be performed by the one or more WWAN transceivers 350, the one or more network transceivers 380, the one or more processors 384, memory 386, and/or positioning component 388, any or all of which may be considered means for performing this operation

At 1520, the base station receives measurement report payload related information for the UE for the positioning session. In an aspect, operation 1520 may be performed by the one or more WWAN transceivers 350, the one or more processors 384, memory 386, and/or positioning component 388, any or all of which may be considered means for performing this operation.

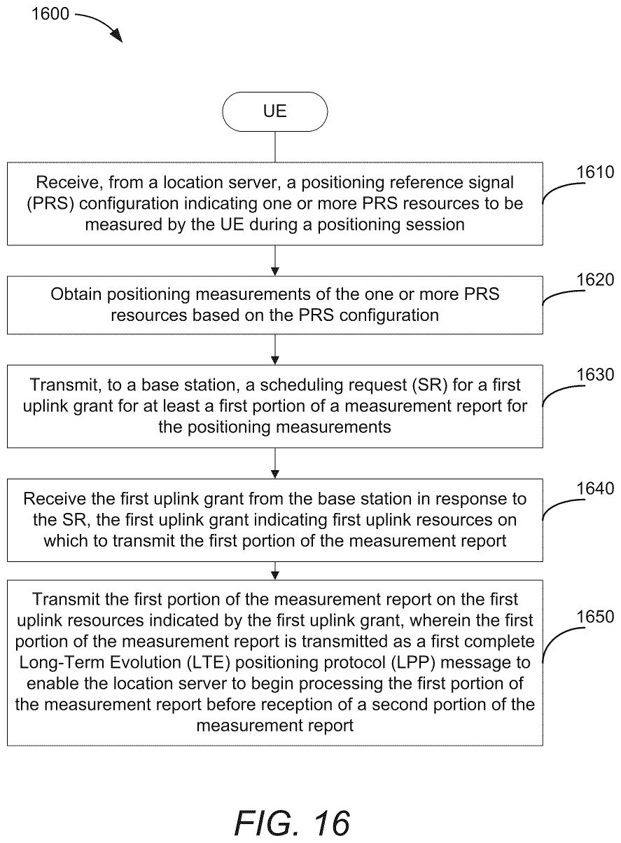

FIG. 16 illustrates an example method 1600 of wireless positioning, according to aspects of the disclosure. In an aspect, method 1600 may be performed by a UE (e.g., any of the UEs described herein).

At 1610, the UE receives, from a location server, a PRS configuration (e.g., PRS configuration 700) indicating one or more PRS resources to be measured by the UE during a positioning session. In an aspect, operation 1610 may be performed by the one or more WWAN transceivers 310, the one or more processors 332, memory 340, and/or positioning component 342, any or all of which may be considered means for performing this operation.

At 1620, the UE obtains positioning measurements of the one or more PRS resources based on the PRS configuration. In an aspect, operation 1620 may be performed by the one or more WWAN transceivers 310, the one or more processors 332, memory 340, and/or positioning component 342, any or all of which may be considered means for performing this operation.

At 1630, the UE transmits, to a base station, an SR for a first uplink grant for at least a first portion of a measurement report for the positioning measurements. In an aspect, operation 1630 may be performed by the one or more WWAN transceivers 310, the one or more processors 332, memory 340, and/or positioning component 342, any or all of which may be considered means for performing this operation.

At 1640, the UE receives the first uplink grant from the base station in response to the SR, the first uplink grant indicating first uplink resources on which to transmit the first portion of the measurement report. In an aspect, operation 1640 may be performed by the one or more WWAN transceivers 310, the one or more processors 332, memory 340, and/or positioning component 342, any or all of which may be considered means for performing this operation.

At 1650, the UE transmits the first portion of the measurement report on the first uplink resources indicated by the first uplink grant, wherein the first portion of the measurement report is transmitted as a first complete LPP message to enable the location server to begin processing the first portion of the measurement report before reception of a second portion of the measurement report. In an aspect, operation 1650 may be performed by the one or more WWAN transceivers 310, the one or more processors 332, memory 340, and/or positioning component 342, any or all of which may be considered means for performing this operation.

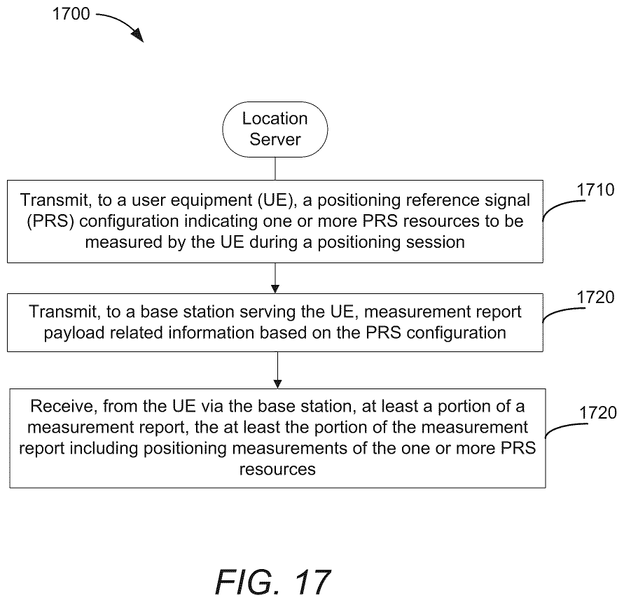

FIG. 17 illustrates an example method 1700 of wireless positioning, according to aspects of the disclosure. In an aspect, method 1700 may be performed by a location server (e.g., LMF 270).

At 1710, the location server transmits, to a UE (e.g., any of the UEs described herein), a PRS configuration (e.g., PRS configuration 700) indicating one or more PRS resources to be measured by the UE during a positioning session, as at stage 530. In an aspect, operation 1710 may be performed by the one or more network transceivers 390, the one or more processors 394, memory 396, and/or positioning component 398, any or all of which may be considered means for performing this operation.

At 1720, the location server transmits, to a base station serving the UE (e.g., any of the base stations described herein), measurement report payload related information based on the PRS configuration. In an aspect, operation 1720 may be performed by the one or more network transceivers 390, the one or more processors 394, memory 396, and/or positioning component 398, any or all of which may be considered means for performing this operation.

At 1730, the location server receives, from the UE via the base station, at least a portion of a measurement report, the at least the portion of the measurement report including positioning measurements of the one or more PRS resources. In an aspect, operation 1730 may be performed by the one or more network transceivers 390, the one or more processors 394, memory 396, and/or positioning component 398, any or all of which may be considered means for performing this operation.

As will be appreciated, a technical advantage of the methods 1400 to 1700 is reduced positioning latency, due to the reduction in time between the measurement of PRS resources and transmission of the associated measurement report.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an clement as both an insulator and a conductor). Furthermore, it is also intended that aspects of a clause can be included in any other independent clause, even if the clause is not directly dependent on the independent clause.

Implementation examples are described in the following numbered clauses:

Clause 1. A method of wireless positioning performed by a user equipment (UE), comprising: receiving, from a location server, a positioning reference signal (PRS) configuration indicating one or more PRS resources to be measured by the UE during a positioning session; transmitting, to a base station serving the UE, measurement report payload related information based on the PRS configuration; and obtaining positioning measurements of the one or more PRS resources based on the PRS configuration.

Clause 2. The method of clause 1, wherein the measurement report payload related information comprises the PRS configuration, an estimated size of the measurement report, or both.

Clause 3. The method of clause 2, further comprising: determining the estimated size of the measurement report based on an estimated number of positioning measurements indicated by the PRS configuration, a minimum number of measurements for the positioning session, a quality of service (QoS) level for the positioning session, outlier rejection results from a previous measurement report, PRS processing capabilities of the UE, or any combination thereof.

Clause 4. The method of any of clauses 1 to 3, further comprising: transmitting, to the base station, an estimated number of positioning measurements indicated by the PRS configuration, a minimum number of measurements for the positioning session, a QoS level for the positioning session, outlier rejection results from a previous measurement report, PRS processing capabilities of the UE, or any combination thereof.

Clause 5. The method of any of clauses 1 to 4, further comprising: transmitting a scheduling request (SR) to the base station, the SR requesting an uplink grant for a measurement report for the positioning measurements; receiving the uplink grant from the base station in response to the SR, the uplink grant indicating uplink resources on which to transmit the measurement report; and transmitting at least a portion of the measurement report to the base station on the uplink resources indicated by the uplink grant.

Clause 6. The method of clause 5, wherein: a size of the uplink grant is based on an estimated size of the measurement report, and the estimated size of the measurement report is based on the measurement report payload related information.

Clause 7. The method of clause 6, wherein: the SR is configured to indicate one of a plurality of different uplink grant sizes, the size of the uplink grant is one uplink grant size of the plurality of different uplink grant sizes, and the size of the uplink grant being based on the estimated size of the measurement report comprises the size of the uplink grant being greater than or equal to the estimated size of the measurement report.

Clause 8. The method of any of clauses 6 to 7, wherein: the SR is one of a plurality of SRs, each SR of the plurality of SRs is associated with an uplink grant having a different size, each SR of the plurality of SRs is scheduled in a different SR occasion, and the size of the uplink grant being based on the estimated size of the measurement report comprises the size of the uplink grant being greater than or equal to the estimated size of the measurement report.

Clause 9. The method of any of clauses 5 to 8, wherein a location of an SR occasion in which the SR is transmitted is based on a location of a measurement gap containing the one or more PRS resources, a location of a measurement period containing the one or more PRS resources, a location of a PRS processing gap during which the one or more PRS resources are processed, a latency requirement for the measurement report, or any combination thereof.

Clause 10. The method of any of clauses 5 to 9, wherein: a size of the uplink grant is smaller than an actual size of the measurement report, and the at least the portion of the measurement report is transmitted as a first complete Long-Term Evolution (LTE) positioning protocol (LPP) message to enable the location server to begin processing the at least the portion of the measurement report before reception of a second portion of the measurement report.

Clause 11. The method of clause 10, further comprising: transmitting a first buffer status report (BSR) with the at least the portion of the measurement report to request a second uplink grant for at least the second portion of the measurement report; and receiving the second uplink grant from the base station in response to the first BSR, the second uplink grant indicating second uplink resources on which to transmit the second portion of the measurement report; and transmitting the second portion of the measurement report on the second uplink resources indicated by the second uplink grant, wherein the second portion of the measurement report is transmitted as a second complete LPP message.

Clause 12. The method of clause 11, further comprising: transmitting a second BSR with the second portion of the measurement report to indicate that the UE bas no more data to transmit.

Clause 13. The method of any of clauses 10 to 12, further comprising: selecting a set of the positioning measurements for the at least the portion of the measurement report based on outlier rejection feedback from a positioning entity.

Clause 14. A method of wireless positioning performed by a base station, comprising: forwarding, from a location server to a user equipment (UE), a positioning reference signal (PRS) configuration indicating one or more PRS resources to be measured by the UE during a positioning session between the UE and the location server; and receiving measurement report payload related information for the UE for the positioning session.

Clause 15. The method of clause 14, wherein: the measurement report payload related information is received from the UE or the location server; and the measurement report payload related information comprises the PRS configuration, an estimated size of the measurement report, or both.

Clause 16. The method of clause 15, further comprising: determining the estimated size of the measurement report based on an estimated number of positioning measurements indicated by the PRS configuration, a minimum number of measurements for the positioning session, a quality of service (QoS) level for the positioning session, outlier rejection results from a previous measurement report, PRS processing capabilities of the UE, or any combination thereof.

Clause 17. The method of any of clauses 14 to 16, further comprising: receiving a scheduling request (SR) from the UE, the SR requesting an uplink grant for a measurement report for the UE to report positioning measurements to a location server involved in a positioning session with the UE; transmitting the uplink grant to the UE in response to the SR, the uplink grant indicating uplink resources for the UE to transmit the measurement report; receiving at least a portion of the measurement report from the UE on the uplink resources indicated by the uplink grant; and forwarding the at least the portion of the measurement report to the location server.

Clause 18. The method of clause 17, wherein: a size of the uplink grant is based on an estimated size of the measurement report, and the estimated size of the measurement report is based on the measurement report payload related information.

Clause 19. The method of clause 18, wherein: the SR is configured to indicate one of a plurality of different uplink grant sizes, the size of the uplink grant is one uplink grant size of the plurality of different uplink grant sizes, and the size of the uplink grant being based on the estimated size of the measurement report comprises the size of the uplink grant being greater than or equal to the estimated size of the measurement report.

Clause 20. The method of any of clauses 18 to 19, wherein: the SR is one of a plurality of SRs, each SR of the plurality of SRs is associated with an uplink grant having a different size, each SR of the plurality of SRs is scheduled in a different SR occasion, and the size of the uplink grant being based on the estimated size of the measurement report comprises the size of the uplink grant being greater than or equal to the estimated size of the measurement report.

Clause 21. The method of any of clauses 17 to 20, wherein a location of an SR occasion in which the SR is received is based on a location of a measurement gap containing the one or more PRS resources, a location of a PRS processing gap during which the one or more PRS resources are processed, a latency requirement for the measurement report, or any combination thereof.

Clause 22. The method of any of clauses 17 to 21, wherein: the size of the uplink grant is smaller than an actual size of the measurement report, and the at least the portion of the measurement report is transmitted as a first complete Long-Term Evolution (LTE) positioning protocol (LPP) message to enable the location server to begin processing the at least the portion of the measurement report before reception of a second portion of the measurement report.

Clause 23. The method of clause 22, further comprising: receiving a first buffer status report (BSR) with the at least the portion of the measurement report, the first BSR, requesting a second uplink grant for at least the second portion of the measurement report; and transmitting the second uplink grant to the UE in response to the first BSR, the second uplink grant indicating second uplink resources on which to transmit the second portion of the measurement report; and receiving the second portion of the measurement report on the second uplink resources indicated by the second uplink grant, wherein the second portion of the measurement report is transmitted as a second complete LPP message.

Clause 24. A method of wireless positioning performed by a user equipment (UE), comprising: receiving, from a location server, a positioning reference signal (PRS) configuration indicating one or more PRS resources to be measured by the UE during a positioning session; obtaining positioning measurements of the one or more PRS resources based on the PRS configuration; transmitting, to a base station, a scheduling request (SR) for a first uplink grant for at least a first portion of a measurement report for the positioning measurements; receiving the first uplink grant from the base station in response to the SR, the first uplink grant indicating first uplink resources on which to transmit the first portion of the measurement report; and transmitting the first portion of the measurement report on the first uplink resources indicated by the first uplink grant, wherein the first portion of the measurement report is transmitted as a first complete Long-Term Evolution (LTE) positioning protocol (LPP) message to enable the location server to begin processing the first portion of the measurement report before reception of a second portion of the measurement report.

Clause 25. The method of any of clauses 23 to 24, further comprising: transmitting a first buffer status report (BSR) on a portion of the first uplink resources to request a second uplink grant for at least the second portion of the measurement report; and receiving the second uplink grant from the base station in response to the first BSR, the second uplink grant indicating second uplink resources on which to transmit the second portion of the measurement report; and transmitting the second portion of the measurement report on the second uplink resources indicated by the second uplink grant, wherein the second portion of the measurement report is transmitted as a second complete LPP message.

Clause 26. The method of any of clauses 24 to 25, further comprising: transmitting a second BSR on a portion of the second uplink resources to indicate that the UE has no more data to transmit.

Clause 27. The method of any of clauses 23 to 26, further comprising: selecting a set of the positioning measurements for the first portion of the measurement report based on outlier rejection feedback from a positioning entity.

Clause 28. The method of any of clauses 26 to 27, wherein the positioning entity is a component of the UE or the location server.

Clause 29. A method of positioning performed by a location server, comprising: transmitting, to a user equipment (UE), a positioning reference signal (PRS) configuration indicating one or more PRS resources to be measured by the UE during a positioning session; transmitting, to a base station serving the UE, measurement report payload related information based on the PRS configuration; and receiving, from the UE via the base station, at least a portion of a measurement report, the at least the portion of the measurement report including positioning measurements of the one or more PRS resources.

Clause 30. The method of clause 29, wherein the measurement report payload related information comprises the PRS configuration, an estimated size of the measurement report, or both.

Clause 31. A user equipment (UE), comprising: a memory; at least one transceiver; and at least one processor communicatively coupled to the memory and the at least one transceiver, the at least one processor configured to: receive, via the at least one transceiver, from a location server, a positioning reference signal (PRS) configuration indicating one or more PRS resources to be measured by the UE during a positioning session; transmit, via the at least one transceiver, to a base station serving the UE, measurement report payload related information based on the PRS configuration; and obtain positioning measurements of the one or more PRS resources based on the PRS configuration.

Clause 32. The UE of clause 31, wherein the measurement report payload related information comprises the PRS configuration, an estimated size of the measurement report, or both.

Clause 33. The UE of clause 32, wherein the at least one processor is further configured to: determine the estimated size of the measurement report based on an estimated number of positioning measurements indicated by the PRS configuration, a minimum number of measurements for the positioning session, a quality of service (QoS) level for the positioning session, outlier rejection results from a previous measurement report, PRS processing capabilities of the UE, or any combination thereof.

Clause 34. The UE of any of clauses 31 to 33, wherein the at least one processor is further configured to: transmit, via the at least one transceiver, to the base station, an estimated number of positioning measurements indicated by the PRS configuration, a minimum number of measurements for the positioning session, a QoS level for the positioning session, outlier rejection results from a previous measurement report, PRS processing capabilities of the UE, or any combination thereof.

Clause 35. The UE of any of clauses 31 to 34, wherein the at least one processor is further configured to: transmit, via the at least one transceiver, a scheduling request (SR) to the base station, the SR requesting an uplink grant for a measurement report for the positioning measurements; receive, via the at least one transceiver, the uplink grant from the base station in response to the SR, the uplink grant indicating uplink resources on which to transmit the measurement report; and transmit, via the at least one transceiver, at least a portion of the measurement report to the base station on the uplink resources indicated by the uplink grant.

Clause 36. The UE of clause 35, wherein: a size of the uplink grant is based on an estimated size of the measurement report, and the estimated size of the measurement report is based on the measurement report payload related information.

Clause 37. The UE of clause 36, wherein: the SR is configured to indicate one of a plurality of different uplink grant sizes, the size of the uplink grant is one uplink grant size of the plurality of different uplink grant sizes, and the size of the uplink grant being based on the estimated size of the measurement report comprises the size of the uplink grant being greater than or equal to the estimated size of the measurement report.

Clause 38. The UE of any of clauses 36 to 37, wherein: the SR is one of a plurality of SRs, each SR of the plurality of SRs is associated with an uplink grant having a different size, each SR of the plurality of SRs is scheduled in a different SR occasion, and the size of the uplink grant being based on the estimated size of the measurement report comprises the size of the uplink grant being greater than or equal to the estimated size of the measurement report.

Clause 39. The UE of any of clauses 35 to 38, wherein a location of an SR occasion in which the SR is transmitted is based on a location of a measurement gap containing the one or more PRS resources, a location of a measurement period containing the one or more PRS resources, a location of a PRS processing gap during which the one or more PRS resources are processed, a latency requirement for the measurement report, or any combination thereof.

Clause 40. The UE of any of clauses 35 to 39, wherein: a size of the uplink grant is smaller than an actual size of the measurement report, and the at least the portion of the measurement report is transmitted as a first complete Long-Term Evolution (LTE) positioning protocol (LPP) message to enable the location server to begin processing the at least the portion of the measurement report before reception of a second portion of the measurement report.

Clause 41. The UE of clause 40, wherein the at least one processor is further configured to: transmit, via the at least one transceiver, a first buffer status report (BSR) with the at least the portion of the measurement report to request a second uplink grant for at least the second portion of the measurement report; and receive, via the at least one transceiver, the second uplink grant from the base station in response to the first BSR, the second uplink grant indicating second uplink resources on which to transmit the second portion of the measurement report; and transmit, via the at least one transceiver, the second portion of the measurement report on the second uplink resources indicated by the second uplink grant, wherein the second portion of the measurement report is transmitted as a second complete LPP message.

Clause 42. The UE of clause 41, wherein the at least one processor is further configured to: transmit, via the at least one transceiver, a second BSR with the second portion of the measurement report to indicate that the UE has no more data to transmit.

Clause 43. The UE of any of clauses 40 to 42, wherein the at least one processor is further configured to: select a set of the positioning measurements for the at least the portion of the measurement report based on outlier rejection feedback from a positioning entity.

Clause 44. A base station, comprising: a memory; at least one transceiver; and at least one processor communicatively coupled to the memory and the at least one transceiver, the at least one processor configured to: forward, from a location server to a user equipment (UE), a positioning reference signal (PRS) configuration indicating one or more PRS resources to be measured by the UE during a positioning session between the UE and the location server; and receive, via the at least one transceiver, measurement report payload related information for the UE for the positioning session.

Clause 45. The base station of clause 44, wherein: the measurement report payload related information is received from the UE or the location server; and the measurement report payload related information comprises the PRS configuration, an estimated size of the measurement report, or both.

Clause 46. The base station of clause 45, wherein the at least one processor is further configured to: determine the estimated size of the measurement report based on an estimated number of positioning measurements indicated by the PRS configuration, a minimum number of measurements for the positioning session, a quality of service (Qos) level for the positioning session, outlier rejection results from a previous measurement report, PRS processing capabilities of the UE, or any combination thereof.

Clause 47. The base station of any of clauses 44 to 46, wherein the at least one processor is further configured to: receive, via the at least one transceiver, a scheduling request (SR) from the UE, the SR requesting an uplink grant for a measurement report for the UE to report positioning measurements to a location server involved in a positioning session with the UE; transmit, via the at least one transceiver, the uplink grant to the UE in response to the SR, the uplink grant indicating uplink resources for the UE to transmit the measurement report; receive, via the at least one transceiver, at least a portion of the measurement report from the UE on the uplink resources indicated by the uplink grant; and forward the at least the portion of the measurement report to the location server.

Clause 48. The base station of clause 47, wherein: a size of the uplink grant is based on an estimated size of the measurement report, and the estimated size of the measurement report is based on the measurement report payload related information.

Clause 49. The base station of clause 48, wherein: the SR is configured to indicate one of a plurality of different uplink grant sizes, the size of the uplink grant is one uplink grant size of the plurality of different uplink grant sizes, and the size of the uplink grant being based on the estimated size of the measurement report comprises the size of the uplink grant being greater than or equal to the estimated size of the measurement report.

Clause 50. The base station of any of clauses 48 to 49, wherein: the SR is one of a plurality of SRs, each SR of the plurality of SRs is associated with an uplink grant having a different size, each SR of the plurality of SRs is scheduled in a different SR occasion, and the size of the uplink grant being based on the estimated size of the measurement report comprises the size of the uplink grant being greater than or equal to the estimated size of the measurement report.

Clause 51. The base station of any of clauses 47 to 50, wherein a location of an SR occasion in which the SR is received is based on a location of a measurement gap containing the one or more PRS resources, a location of a PRS processing gap during which the one or more PRS resources are processed, a latency requirement for the measurement report, or any combination thereof.

Clause 52. The base station of any of clauses 47 to 51, wherein: the size of the uplink grant is smaller than an actual size of the measurement report, and the at least the portion of the measurement report is transmitted as a first complete Long-Term Evolution (LTE) positioning protocol (LPP) message to enable the location server to begin processing the at least the portion of the measurement report before reception of a second portion of the measurement report.

Clause 53. The base station of clause 52, wherein the at least one processor is further configured to: receive, via the at least one transceiver, a first buffer status report (BSR) with the at least the portion of the measurement report, the first BSR requesting a second uplink grant for at least the second portion of the measurement report; and transmit, via the at least one transceiver, the second uplink grant to the UE in response to the first BSR, the second uplink grant indicating second uplink resources on which to transmit the second portion of the measurement report; and receive, via the at least one transceiver, the second portion of the measurement report on the second uplink resources indicated by the second uplink grant, wherein the second portion of the measurement report is transmitted as a second complete LPP message.

Clause 54. The base station of any of clauses 52 to 53, wherein the at least one processor is further configured to: transmit, via the at least one transceiver, a first buffer status report (BSR) on a portion of the first uplink resources to request a second uplink grant for at least the second portion of the measurement report; and receive, via the at least one transceiver, the second uplink grant from the base station in response to the first BSR, the second uplink grant indicating second uplink resources on which to transmit the second portion of the measurement report; and transmit, via the at least one transceiver, the second portion of the measurement report on the second uplink resources indicated by the second uplink grant, wherein the second portion of the measurement report is transmitted as a second complete LPP message.

Clause 55. The base station of any of clauses 51 to 54, wherein the at least one processor is further configured to: select a set of the positioning measurements for the first portion of the measurement report based on outlier rejection feedback from a positioning entity.

Clause 56. A user equipment (UE), comprising: a memory; at least one transceiver; and at least one processor communicatively coupled to the memory and the at least one transceiver, the at least one processor configured to: receive, via the at least one transceiver, from a location server, a positioning reference signal (PRS) configuration indicating one or more PRS resources to be measured by the UE during a positioning session; obtain positioning measurements of the one or more PRS resources based on the PRS configuration; transmit, via the at least one transceiver, to a base station, a scheduling request (SR) for a first uplink grant for at least a first portion of a measurement report for the positioning measurements; receive, via the at least one transceiver, the first uplink grant from the base station in response to the SR, the first uplink grant indicating first uplink resources on which to transmit the first portion of the measurement report; and transmit, via the at least one transceiver, the first portion of the measurement report on the first uplink resources indicated by the first uplink grant, wherein the first portion of the measurement report is transmitted as a first complete Long-Term Evolution (LTE) positioning protocol (LPP) message to enable the location server to begin processing the first portion of the measurement report before reception of a second portion of the measurement report.

Clause 57. The UE of any of clauses 55 to 56, wherein the at least one processor is further configured to: transmit, via the at least one transceiver, a second BSR on a portion of the second uplink resources to indicate that the UE has no more data to transmit.

Clause 58. The UE of any of clauses 56 to 57, wherein the positioning entity is a component of the UE or the location server.

Clause 59. A location server, comprising: a memory; at least one transceiver; and at least one processor communicatively coupled to the memory and the at least one transceiver, the at least one processor configured to: transmit, via the at least one transceiver, to a user equipment (UE), a positioning reference signal (PRS) configuration indicating one or more PRS resources to be measured by the UE during a positioning session; transmit, via the at least one transceiver, to a base station serving the UE, measurement report payload related information based on the PRS configuration; and receive, via the at least one transceiver, from the UE via the base station, at least a portion of a measurement report, the at least the portion of the measurement report including positioning measurements of the one or more PRS resources.

Clause 60. The location server of clause 59, wherein the measurement report payload related information comprises the PRS configuration, an estimated size of the measurement report, or both.

Clause 61. A user equipment (UE), comprising: means for receiving, from a location server, a positioning reference signal (PRS) configuration indicating one or more PRS resources to be measured by the UE during a positioning session; means for transmitting, to a base station serving the UE, measurement report payload related information based on the PRS configuration; and means for obtaining positioning measurements of the one or more PRS resources based on the PRS configuration.

Clause 62. The UE of clause 61, wherein the measurement report payload related information comprises the PRS configuration, an estimated size of the measurement report, or both.

Clause 63. The UE of clause 62, further comprising: means for determining the estimated size of the measurement report based on an estimated number of positioning measurements indicated by the PRS configuration, a minimum number of measurements for the positioning session, a quality of service (QoS) level for the positioning session, outlier rejection results from a previous measurement report, PRS processing capabilities of the UE, or any combination thereof.

Clause 64. The UE of any of clauses 61 to 63, further comprising: means for transmitting, to the base station, an estimated number of positioning measurements indicated by the PRS configuration, a minimum number of measurements for the positioning session, a QoS level for the positioning session, outlier rejection results from a previous measurement report, PRS processing capabilities of the UE, or any combination thereof.

Clause 65. The UE of any of clauses 61 to 64, further comprising: means for transmitting a scheduling request (SR) to the base station, the SR requesting an uplink grant for a measurement report for the positioning measurements; means for receiving the uplink grant from the base station in response to the SR, the uplink grant indicating uplink resources on which to transmit the measurement report; and means for transmitting at least a portion of the measurement report to the base station on the uplink resources indicated by the uplink grant.

Clause 66. The UE of clause 65, wherein: a size of the uplink grant is based on an estimated size of the measurement report, and the estimated size of the measurement report is based on the measurement report payload related information.

Clause 67. The UE of clause 66, wherein: the SR is configured to indicate one of a plurality of different uplink grant sizes, the size of the uplink grant is one uplink grant size of the plurality of different uplink grant sizes, and the size of the uplink grant being based on the estimated size of the measurement report comprises the size of the uplink grant being greater than or equal to the estimated size of the measurement report.

Clause 68. The UE of any of clauses 66 to 67, wherein: the SR is one of a plurality of SRs, each SR of the plurality of SRs is associated with an uplink grant having a different size, each SR of the plurality of SRs is scheduled in a different SR occasion, and the size of the uplink grant being based on the estimated size of the measurement report comprises the size of the uplink grant being greater than or equal to the estimated size of the measurement report.

Clause 69. The UE of any of clauses 65 to 68, wherein a location of an SR occasion in which the SR is transmitted is based on a location of a measurement gap containing the one or more PRS resources, a location of a measurement period containing the one or more PRS resources, a location of a PRS processing gap during which the one or more PRS resources are processed, a latency requirement for the measurement report, or any combination thereof.

Clause 70. The UE of any of clauses 65 to 69, wherein: a size of the uplink grant is smaller than an actual size of the measurement report, and the at least the portion of the measurement report is transmitted as a first complete Long-Term Evolution (LTE) positioning protocol (LPP) message to enable the location server to begin processing the at least the portion of the measurement report before reception of a second portion of the measurement report.

Clause 71. The UE of clause 70, further comprising: means for transmitting a first buffer status report (BSR) with the at least the portion of the measurement report to request a second uplink grant for at least the second portion of the measurement report; and means for receiving the second uplink grant from the base station in response to the first BSR, the second uplink grant indicating second uplink resources on which to transmit the second portion of the measurement report; and means for transmitting the second portion of the measurement report on the second uplink resources indicated by the second uplink grant, wherein the second portion of the measurement report is transmitted as a second complete LPP message.

Clause 72. The UE of clause 71, further comprising: means for transmitting a second BSR with the second portion of the measurement report to indicate that the UE bas no more data to transmit.

Clause 73. The UE of any of clauses 70 to 72, further comprising: means for selecting a set of the positioning measurements for the at least the portion of the measurement report based on outlier rejection feedback from a positioning entity.

Clause 74. A base station, comprising: means for forwarding, from a location server to a user equipment (UE), a positioning reference signal (PRS) configuration indicating one or more PRS resources to be measured by the UE during a positioning session between the UE and the location server; and means for receiving measurement report payload related information for the UE for the positioning session.

Clause 75. The base station of clause 74, wherein: the measurement report payload related information is received from the UE or the location server; and the measurement report payload related information comprises the PRS configuration, an estimated size of the measurement report, or both.

Clause 76. The base station of clause 75, further comprising: means for determining the estimated size of the measurement report based on an estimated number of positioning measurements indicated by the PRS configuration, a minimum number of measurements for the positioning session, a quality of service (QoS) level for the positioning session, outlier rejection results from a previous measurement report, PRS processing capabilities of the UE, or any combination thereof.

Clause 77. The base station of any of clauses 74 to 76, further comprising: means for receiving a scheduling request (SR) from the UE, the SR requesting an uplink grant for a measurement report for the UE to report positioning measurements to a location server involved in a positioning session with the UE; means for transmitting the uplink grant to the UE in response to the SR, the uplink grant indicating uplink resources for the UE to transmit the measurement report; means for receiving at least a portion of the measurement report from the UE on the uplink resources indicated by the uplink grant; and means for forwarding the at least the portion of the measurement report to the location server.

Clause 78. The base station of clause 77, wherein: a size of the uplink grant is based on an estimated size of the measurement report, and the estimated size of the measurement report is based on the measurement report payload related information.

Clause 79. The base station of clause 78, wherein: the SR is configured to indicate one of a plurality of different uplink grant sizes, the size of the uplink grant is one uplink grant size of the plurality of different uplink grant sizes, and the size of the uplink grant being based on the estimated size of the measurement report comprises the size of the uplink grant being greater than or equal to the estimated size of the measurement report.

Clause 80. The base station of any of clauses 78 to 79, wherein: the SR is one of a plurality of SRs, each SR of the plurality of SRs is associated with an uplink grant having a different size, each SR of the plurality of SRs is scheduled in a different SR occasion, and the size of the uplink grant being based on the estimated size of the measurement report comprises the size of the uplink grant being greater than or equal to the estimated size of the measurement report.

Clause 81. The base station of any of clauses 77 to 80, wherein a location of an SR occasion in which the SR is received is based on a location of a measurement gap containing the one or more PRS resources, a location of a PRS processing gap during which the one or more PRS resources are processed, a latency requirement for the measurement report, or any combination thereof.

Clause 82. The base station of any of clauses 77 to 81, wherein: the size of the uplink grant is smaller than an actual size of the measurement report, and the at least the portion of the measurement report is transmitted as a first complete Long-Term Evolution (LTE) positioning protocol (LPP) message to enable the location server to begin processing the at least the portion of the measurement report before reception of a second portion of the measurement report.

Clause 83. The base station of clause 82, further comprising: means for receiving a first buffer status report (BSR) with the at least the portion of the measurement report, the first BSR requesting a second uplink grant for at least the second portion of the measurement report; and means for transmitting the second uplink grant to the UE in response to the first BSR, the second uplink grant indicating second uplink resources on which to transmit the second portion of the measurement report; and means for receiving the second portion of the measurement report on the second uplink resources indicated by the second uplink grant, wherein the second portion of the measurement report is transmitted as a second complete LPP message.

Clause 84. The base station of any of clauses 82 to 83, further comprising: means for transmitting a first buffer status report (BSR) on a portion of the first uplink resources to request a second uplink grant for at least the second portion of the measurement report; and means for receiving the second uplink grant from the base station in response to the first BSR, the second uplink grant indicating second uplink resources on which to transmit the second portion of the measurement report; and means for transmitting the second portion of the measurement report on the second uplink resources indicated by the second uplink grant, wherein the second portion of the measurement report is transmitted as a second complete LPP message.

Clause 85. The base station of any of clauses 81 to 84, further comprising: means for selecting a set of the positioning measurements for the first portion of the measurement report based on outlier rejection feedback from a positioning entity.

Clause 86. A user equipment (UE), comprising: means for receiving, from a location server, a positioning reference signal (PRS) configuration indicating one or more PRS resources to be measured by the UE during a positioning session; means for obtaining positioning measurements of the one or more PRS resources based on the PRS configuration; means for transmitting, to a base station, a scheduling request (SR) for a first uplink grant for at least a first portion of a measurement report for the positioning measurements; means for receiving the first uplink grant from the base station in response to the SR, the first uplink grant indicating first uplink resources on which to transmit the first portion of the measurement report; and means for transmitting the first portion of the measurement report on the first uplink resources indicated by the first uplink grant, wherein the first portion of the measurement report is transmitted as a first complete Long-Term Evolution (LTE) positioning protocol (LPP) message to enable the location server to begin processing the first portion of the measurement report before reception of a second portion of the measurement report.

Clause 87. The UE of any of clauses 85 to 86, further comprising: means for transmitting a second BSR on a portion of the second uplink resources to indicate that the UE has no more data to transmit.

Clause 88. The UE of any of clauses 86 to 87, wherein the positioning entity is a component of the UE or the location server.

Clause 89. A location server, comprising: means for transmitting, to a user equipment (UE), a positioning reference signal (PRS) configuration indicating one or more PRS resources to be measured by the UE during a positioning session; means for transmitting, to a base station serving the UE, measurement report payload related information based on the PRS configuration; and means for receiving, from the UE via the base station, at least a portion of a measurement report, the at least the portion of the measurement report including positioning measurements of the one or more PRS resources.

Clause 90. The location server of clause 89, wherein the measurement report payload related information comprises the PRS configuration, an estimated size of the measurement report, or both.

Clause 91. A non-transitory computer-readable medium storing computer-executable instructions that, when executed by a user equipment (UE), cause the UE to: receive, from a location server, a positioning reference signal (PRS) configuration indicating one or more PRS resources to be measured by the UE during a positioning session; transmit, to a base station serving the UE, measurement report payload related information based on the PRS configuration; and obtain positioning measurements of the one or more PRS resources based on the PRS configuration.

Clause 92. The non-transitory computer-readable medium of clause 91, wherein the measurement report payload related information comprises the PRS configuration, an estimated size of the measurement report, or both.

Clause 93. The non-transitory computer-readable medium of clause 92, further comprising computer-executable instructions that, when executed by the UE, cause the UE to: determine the estimated size of the measurement report based on an estimated number of positioning measurements indicated by the PRS configuration, a minimum number of measurements for the positioning session, a quality of service (QoS) level for the positioning session, outlier rejection results from a previous measurement report, PRS processing capabilities of the UE, or any combination thereof.

Clause 94. The non-transitory computer-readable medium of any of clauses 91 to 93, further comprising computer-executable instructions that, when executed by the UE, cause the UE to: transmit, to the base station, an estimated number of positioning measurements indicated by the PRS configuration, a minimum number of measurements for the positioning session, a QoS level for the positioning session, outlier rejection results from a previous measurement report, PRS processing capabilities of the UE, or any combination thereof.

Clause 95. The non-transitory computer-readable medium of any of clauses 91 to 94, further comprising computer-executable instructions that, when executed by the UE, cause the UE to: transmit a scheduling request (SR) to the base station, the SR requesting an uplink grant for a measurement report for the positioning measurements; receive the uplink grant from the base station in response to the SR, the uplink grant indicating uplink resources on which to transmit the measurement report; and transmit at least a portion of the measurement report to the base station on the uplink resources indicated by the uplink grant.

Clause 96. The non-transitory computer-readable medium of clause 95, wherein: a size of the uplink grant is based on an estimated size of the measurement report, and the estimated size of the measurement report is based on the measurement report payload related information.

Clause 97. The non-transitory computer-readable medium of clause 96, wherein: the SR is configured to indicate one of a plurality of different uplink grant sizes, the size of the uplink grant is one uplink grant size of the plurality of different uplink grant sizes, and the size of the uplink grant being based on the estimated size of the measurement report comprises the size of the uplink grant being greater than or equal to the estimated size of the measurement report.

Clause 98. The non-transitory computer-readable medium of any of clauses 96 to 97, wherein: the SR is one of a plurality of SRs, each SR of the plurality of SRs is associated with an uplink grant having a different size, each SR of the plurality of SRs is scheduled in a different SR occasion, and the size of the uplink grant being based on the estimated size of the measurement report comprises the size of the uplink grant being greater than or equal to the estimated size of the measurement report.

Clause 99. The non-transitory computer-readable medium of any of clauses 95 to 98, wherein a location of an SR occasion in which the SR is transmitted is based on a location of a measurement gap containing the one or more PRS resources, a location of a measurement period containing the one or more PRS resources, a location of a PRS processing gap during which the one or more PRS resources are processed, a latency requirement for the measurement report, or any combination thereof.

Clause 100. The non-transitory computer-readable medium of any of clauses 95 to 99, wherein: a size of the uplink grant is smaller than an actual size of the measurement report, and the at least the portion of the measurement report is transmitted as a first complete Long-Term Evolution (LTE) positioning protocol (LPP) message to enable the location server to begin processing the at least the portion of the measurement report before reception of a second portion of the measurement report.

Clause 101. The non-transitory computer-readable medium of clause 100, further comprising computer-executable instructions that, when executed by the UE, cause the UE to: transmit a first buffer status report (BSR) with the at least the portion of the measurement report to request a second uplink grant for at least the second portion of the measurement report; and receive the second uplink grant from the base station in response to the first BSR, the second uplink grant indicating second uplink resources on which to transmit the second portion of the measurement report; and transmit the second portion of the measurement report on the second uplink resources indicated by the second uplink grant, wherein the second portion of the measurement report is transmitted as a second complete LPP message.

Clause 102. The non-transitory computer-readable medium of clause 101, further comprising computer-executable instructions that, when executed by the UE, cause the UE to: transmit a second BSR with the second portion of the measurement report to indicate that the UE has no more data to transmit.

Clause 103. The non-transitory computer-readable medium of any of clauses 100 to 102, further comprising computer-executable instructions that, when executed by the UE, cause the UE to: select a set of the positioning measurements for the at least the portion of the measurement report based on outlier rejection feedback from a positioning entity.

Clause 104. A non-transitory computer-readable medium storing computer-executable instructions that, when executed by a base station, cause the base station to: forward, from a location server to a user equipment (UE), a positioning reference signal (PRS) configuration indicating one or more PRS resources to be measured by the UE during a positioning session between the UE and the location server; and receive measurement report payload related information for the UE for the positioning session.

Clause 105. The non-transitory computer-readable medium of clause 104, wherein: the measurement report payload related information is received from the UE or the location server; and the measurement report payload related information comprises the PRS configuration, an estimated size of the measurement report, or both.

Clause 106. The non-transitory computer-readable medium of clause 105, further comprising computer-executable instructions that, when executed by the base station, cause the base station to: determine the estimated size of the measurement report based on an estimated number of positioning measurements indicated by the PRS configuration, a minimum number of measurements for the positioning session, a quality of service (QoS) level for the positioning session, outlier rejection results from a previous measurement report, PRS processing capabilities of the UE, or any combination thereof.

Clause 107. The non-transitory computer-readable medium of any of clauses 104 to 106, further comprising computer-executable instructions that, when executed by the base station, cause the base station to: receive a scheduling request (SR) from the UE, the SR requesting an uplink grant for a measurement report for the UE to report positioning measurements to a location server involved in a positioning session with the UE; transmit the uplink grant to the UE in response to the SR, the uplink grant indicating uplink resources for the UE to transmit the measurement report; receive at least a portion of the measurement report from the UE on the uplink resources indicated by the uplink grant; and forward the at least the portion of the measurement report to the location server.

Clause 108. The non-transitory computer-readable medium of clause 107, wherein: a size of the uplink grant is based on an estimated size of the measurement report, and the estimated size of the measurement report is based on the measurement report payload related information.

Clause 109. The non-transitory computer-readable medium of clause 108, wherein: the SR is configured to indicate one of a plurality of different uplink grant sizes, the size of the uplink grant is one uplink grant size of the plurality of different uplink grant sizes, and the size of the uplink grant being based on the estimated size of the measurement report comprises the size of the uplink grant being greater than or equal to the estimated size of the measurement report.

Clause 110. The non-transitory computer-readable medium of any of clauses 108 to 109, wherein: the SR is one of a plurality of SRs, each SR of the plurality of SRs is associated with an uplink grant having a different size, each SR of the plurality of SRs is scheduled in a different SR occasion, and the size of the uplink grant being based on the estimated size of the measurement report comprises the size of the uplink grant being greater than or equal to the estimated size of the measurement report.

Clause 111. The non-transitory computer-readable medium of any of clauses 107 to 110, wherein a location of an SR occasion in which the SR is received is based on a location of a measurement gap containing the one or more PRS resources, a location of a PRS processing gap during which the one or more PRS resources are processed, a latency requirement for the measurement report, or any combination thereof.

Clause 112. The non-transitory computer-readable medium of any of clauses 107 to 111, wherein: the size of the uplink grant is smaller than an actual size of the measurement report, and the at least the portion of the measurement report is transmitted as a first complete Long-Term Evolution (LTE) positioning protocol (LPP) message to enable the location server to begin processing the at least the portion of the measurement report before reception of a second portion of the measurement report.

Clause 113. The non-transitory computer-readable medium of clause 112, further comprising computer-executable instructions that, when executed by the base station, cause the base station to: receive a first buffer status report (BSR) with the at least the portion of the measurement report, the first BSR requesting a second uplink grant for at least the second portion of the measurement report; and transmit the second uplink grant to the UE in response to the first BSR, the second uplink grant indicating second uplink resources on which to transmit the second portion of the measurement report; and receive the second portion of the measurement report on the second uplink resources indicated by the second uplink grant, wherein the second portion of the measurement report is transmitted as a second complete LPP message.

Clause 114. The non-transitory computer-readable medium of any of clauses 112 to 113, further comprising computer-executable instructions that, when executed by the base station, cause the base station to: transmit a first buffer status report (BSR) on a portion of the first uplink resources to request a second uplink grant for at least the second portion of the measurement report; and receive the second uplink grant from the base station in response to the first BSR, the second uplink grant indicating second uplink resources on which to transmit the second portion of the measurement report; and transmit the second portion of the measurement report on the second uplink resources indicated by the second uplink grant, wherein the second portion of the measurement report is transmitted as a second complete LPP message.

Clause 115. The non-transitory computer-readable medium of any of clauses 111 to 114, further comprising computer-executable instructions that, when executed by the base station, cause the base station to: select a set of the positioning measurements for the first portion of the measurement report based on outlier rejection feedback from a positioning entity.

Clause 116. A non-transitory computer-readable medium storing computer-executable instructions that, when executed by a user equipment (UE), cause the UE to: receive, from a location server, a positioning reference signal (PRS) configuration indicating one or more PRS resources to be measured by the UE during a positioning session; obtain positioning measurements of the one or more PRS resources based on the PRS configuration; transmit, to a base station, a scheduling request (SR) for a first uplink grant for at least a first portion of a measurement report for the positioning measurements; receive the first uplink grant from the base station in response to the SR, the first uplink grant indicating first uplink resources on which to transmit the first portion of the measurement report; and transmit the first portion of the measurement report on the first uplink resources indicated by the first uplink grant, wherein the first portion of the measurement report is transmitted as a first complete Long-Term Evolution (LTE) positioning protocol (LPP) message to enable the location server to begin processing the first portion of the measurement report before reception of a second portion of the measurement report.

Clause 117. The non-transitory computer-readable medium of any of clauses 115 to 116, further comprising computer-executable instructions that, when executed by the UE, cause the UE to: transmit a second BSR on a portion of the second uplink resources to indicate that the UE has no more data to transmit.

Clause 118. The non-transitory computer-readable medium of any of clauses 116 to 117, wherein the positioning entity is a component of the UE or the location server.

Clause 119. A non-transitory computer-readable medium storing computer-executable instructions that, when executed by a location server, cause the location server to: transmit, to a user equipment (UE), a positioning reference signal (PRS) configuration indicating one or more PRS resources to be measured by the UE during a positioning session; transmit, to a base station serving the UE, measurement report payload related information based on the PRS configuration; and receive, from the UE via the base station, at least a portion of a measurement report, the at least the portion of the measurement report including positioning measurements of the one or more PRS resources.

Clause 120. The non-transitory computer-readable medium of clause 119, wherein the measurement report payload related information comprises the PRS configuration, an estimated size of the measurement report, or both.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents. electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of wireless positioning performed by a user equipment (UE), comprising:
receiving, from a location server, a positioning reference signal (PRS) configuration indicating one or more PRS resources to be measured by the UE during a positioning session;
transmitting, to a base station serving the UE, measurement report payload related information based on the PRS configuration; and
obtaining positioning measurements of the one or more PRS resources based on the PRS configuration.

2. The method of claim 1, wherein the measurement report payload related information comprises the PRS configuration, an estimated size of the measurement report, or both.

3. The method of claim 2, further comprising:
determining the estimated size of the measurement report based on an estimated number of positioning measurements indicated by the PRS configuration, a minimum number of measurements for the positioning session, a quality of service (QoS) level for the positioning session, outlier rejection results from a previous measurement report, PRS processing capabilities of the UE, or any combination thereof.

4. The method of claim 1, further comprising:
transmitting, to the base station, an estimated number of positioning measurements indicated by the PRS configuration, a minimum number of measurements for the positioning session, a QoS level for the positioning session, outlier rejection results from a previous measurement report, PRS processing capabilities of the UE, or any combination thereof.

5. The method of claim 1, further comprising:
transmitting a scheduling request (SR) to the base station, the SR requesting an uplink grant for a measurement report for the positioning measurements;
receiving the uplink grant from the base station in response to the SR, the uplink grant indicating uplink resources on which to transmit the measurement report; and
transmitting at least a portion of the measurement report to the base station on the uplink resources indicated by the uplink grant.

6. The method of claim 5, wherein:
a size of the uplink grant is based on an estimated size of the measurement report, and
the estimated size of the measurement report is based on the measurement report payload related information.

7. The method of claim 6, wherein:
the SR is configured to indicate one of a plurality of different uplink grant sizes,
the size of the uplink grant is one uplink grant size of the plurality of different uplink grant sizes, and
the size of the uplink grant being based on the estimated size of the measurement report comprises the size of the uplink grant being greater than or equal to the estimated size of the measurement report.

8. The method of claim 6, wherein:
the SR is one of a plurality of SRs,
each SR of the plurality of SRs is associated with an uplink grant having a different size,
each SR of the plurality of SRs is scheduled in a different SR occasion, and
the size of the uplink grant being based on the estimated size of the measurement report comprises the size of the uplink grant being greater than or equal to the estimated size of the measurement report.

9. The method of claim 5, wherein a location of an SR occasion in which the SR is transmitted is based on a location of a measurement gap containing the one or more PRS resources, a location of a measurement period containing the one or more PRS resources, a location of a PRS processing gap during which the one or more PRS resources are processed, a latency requirement for the measurement report, or any combination thereof.

10. The method of claim 5, wherein:
a size of the uplink grant is smaller than an actual size of the measurement report, and
the at least the portion of the measurement report is transmitted as a first complete Long-Term Evolution (LTE) positioning protocol (LPP) message to enable the location server to begin processing the at least the portion of the measurement report before reception of a second portion of the measurement report.

11. The method of claim 10, further comprising:
transmitting a first buffer status report (BSR) with the at least the portion of the measurement report to request a second uplink grant for at least the second portion of the measurement report; and
receiving the second uplink grant from the base station in response to the first BSR, the second uplink grant indicating second uplink resources on which to transmit the second portion of the measurement report; and
transmitting the second portion of the measurement report on the second uplink resources indicated by the second uplink grant, wherein the second portion of the measurement report is transmitted as a second complete LPP message.

12. The method of claim 11, further comprising:
transmitting a second BSR with the second portion of the measurement report to indicate that the UE has no more data to transmit.

13. The method of claim 10, further comprising:
selecting a set of the positioning measurements for the at least the portion of the measurement report based on outlier rejection feedback from a positioning entity.

14. A method of wireless positioning performed by a base station, comprising:
forwarding, from a location server to a user equipment (UE), a positioning reference signal (PRS) configuration indicating one or more PRS resources to be measured by the UE during a positioning session between the UE and the location server; and
receiving measurement report payload related information for the UE for the positioning session.

15. The method of claim 14, wherein:
the measurement report payload related information is received from the UE or the location server; and
the measurement report payload related information comprises the PRS configuration, an estimated size of the measurement report, or both.

16. The method of claim 15, further comprising:
determining the estimated size of the measurement report based on an estimated number of positioning measurements indicated by the PRS configuration, a minimum number of measurements for the positioning session, a quality of service (QoS) level for the positioning session, outlier rejection results from a previous measurement report, PRS processing capabilities of the UE, or any combination thereof.

17. The method of claim 14, further comprising:
receiving a scheduling request (SR) from the UE, the SR requesting an uplink grant for a measurement report for the UE to report positioning measurements to a location server involved in a positioning session with the UE;
transmitting the uplink grant to the UE in response to the SR, the uplink grant indicating uplink resources for the UE to transmit the measurement report;
receiving at least a portion of the measurement report from the UE on the uplink resources indicated by the uplink grant; and
forwarding the at least the portion of the measurement report to the location server.

18. The method of claim 17, wherein:
a size of the uplink grant is based on an estimated size of the measurement report, and
the estimated size of the measurement report is based on the measurement report payload related information.

19. The method of claim 18, wherein:
the SR is configured to indicate one of a plurality of different uplink grant sizes,
the size of the uplink grant is one uplink grant size of the plurality of different uplink grant sizes, and
the size of the uplink grant being based on the estimated size of the measurement report comprises the size of the uplink grant being greater than or equal to the estimated size of the measurement report.

20. The method of claim 18, wherein:
the SR is one of a plurality of SRs,
each SR of the plurality of SRs is associated with an uplink grant having a different size,
each SR of the plurality of SRs is scheduled in a different SR occasion, and
the size of the uplink grant being based on the estimated size of the measurement report comprises the size of the uplink grant being greater than or equal to the estimated size of the measurement report.

21. The method of claim 17, wherein a location of an SR occasion in which the SR is received is based on a location of a measurement gap containing the one or more PRS resources, a location of a PRS processing gap during which the one or more PRS resources are processed, a latency requirement for the measurement report, or any combination thereof.

22. The method of claim 17, wherein:
the size of the uplink grant is smaller than an actual size of the measurement report, and
the at least the portion of the measurement report is transmitted as a first complete Long-Term Evolution (LTE) positioning protocol (LPP) message to enable the location server to begin processing the at least the portion of the measurement report before reception of a second portion of the measurement report.

23. The method of claim 22, further comprising:
receiving a first buffer status report (BSR) with the at least the portion of the measurement report, the first BSR requesting a second uplink grant for at least the second portion of the measurement report; and
transmitting the second uplink grant to the UE in response to the first BSR, the second uplink grant indicating second uplink resources on which to transmit the second portion of the measurement report; and
receiving the second portion of the measurement report on the second uplink resources indicated by the second uplink grant, wherein the second portion of the measurement report is transmitted as a second complete LPP message.

24. A method of wireless positioning performed by a user equipment (UE), comprising:
receiving, from a location server, a positioning reference signal (PRS) configuration indicating one or more PRS resources to be measured by the UE during a positioning session;
obtaining positioning measurements of the one or more PRS resources based on the PRS configuration;
transmitting, to a base station, a scheduling request (SR) for a first uplink grant for at least a first portion of a measurement report for the positioning measurements;
receiving the first uplink grant from the base station in response to the SR, the first uplink grant indicating first uplink resources on which to transmit the first portion of the measurement report; and
transmitting the first portion of the measurement report on the first uplink resources indicated by the first uplink grant, wherein the first portion of the measurement report is transmitted as a first complete Long-Term Evolution (LTE) positioning protocol (LPP) message to enable the location server to begin processing the first portion of the measurement report before reception of a second portion of the measurement report.

25. The method of claim 24, further comprising:
transmitting a first buffer status report (BSR) on a portion of the first uplink resources to request a second uplink grant for at least the second portion of the measurement report; and
receiving the second uplink grant from the base station in response to the first BSR, the second uplink grant indicating second uplink resources on which to transmit the second portion of the measurement report; and
transmitting the second portion of the measurement report on the second uplink resources indicated by the second uplink grant, wherein the second portion of the measurement report is transmitted as a second complete LPP message.

26. The method of claim 25, further comprising:
transmitting a second BSR on a portion of the second uplink resources to indicate that the UE bas no more data to transmit.

27. The method of claim 24, further comprising:
selecting a set of the positioning measurements for the first portion of the measurement report based on outlier rejection feedback from a positioning entity.

28. The method of claim 27, wherein the positioning entity is a component of the UE or the location server.

29. A method of positioning performed by a location server, comprising:
transmitting, to a user equipment (UE), a positioning reference signal (PRS) configuration indicating one or more PRS resources to be measured by the UE during a positioning session;
transmitting, to a base station serving the UE, measurement report payload related information based on the PRS configuration; and
receiving, from the UE via the base station, at least a portion of a measurement report, the at least the portion of the measurement report including positioning measurements of the one or more PRS resources.

30. The method of claim 29, wherein the measurement report payload related information comprises the PRS configuration, an estimated size of the measurement report, or both.

31. A user equipment (UE), comprising:
a memory;
at least one transceiver; and
at least one processor communicatively coupled to the memory and the at least one transceiver, the at least one processor configured to:
receive, via the at least one transceiver, from a location server, a positioning reference signal (PRS) configuration indicating one or more PRS resources to be measured by the UE during a positioning session;
transmit, via the at least one transceiver, to a base station serving the UE, measurement report payload related information based on the PRS configuration; and
obtain positioning measurements of the one or more PRS resources based on the PRS configuration.

32. The UE of claim 31, wherein the measurement report payload related information comprises the PRS configuration, an estimated size of the measurement report, or both.

33. The UE of claim 32, wherein the at least one processor is further configured to:
determine the estimated size of the measurement report based on an estimated number of positioning measurements indicated by the PRS configuration, a minimum number of measurements for the positioning session, a quality of service (QOS) level for the positioning session, outlier rejection results from a previous measurement report, PRS processing capabilities of the UE, or any combination thereof.

34. The UE of claim 31, wherein the at least one processor is further configured to:
transmit, via the at least one transceiver, to the base station, an estimated number of positioning measurements indicated by the PRS configuration, a minimum number of measurements for the positioning session, a QoS level for the positioning session, outlier rejection results from a previous measurement report, PRS processing capabilities of the UE, or any combination thereof.

35. The UE of claim 31, wherein the at least one processor is further configured to:
transmit, via the at least one transceiver, a scheduling request (SR) to the base station, the SR requesting an uplink grant for a measurement report for the positioning measurements;
receive, via the at least one transceiver, the uplink grant from the base station in response to the SR, the uplink grant indicating uplink resources on which to transmit the measurement report; and
transmit, via the at least one transceiver, at least a portion of the measurement report to the base station on the uplink resources indicated by the uplink grant.

36. The UE of claim 35, wherein:
a size of the uplink grant is based on an estimated size of the measurement report, and
the estimated size of the measurement report is based on the measurement report payload related information.

37. The UE of claim 36, wherein:
the SR is configured to indicate one of a plurality of different uplink grant sizes,
the size of the uplink grant is one uplink grant size of the plurality of different uplink grant sizes, and
the size of the uplink grant being based on the estimated size of the measurement report comprises the size of the uplink grant being greater than or equal to the estimated size of the measurement report.

38. The UE of claim 36, wherein:
the SR is one of a plurality of SRs,
each SR of the plurality of SRs is associated with an uplink grant having a different size,
each SR of the plurality of SRs is scheduled in a different SR occasion, and
the size of the uplink grant being based on the estimated size of the measurement report comprises the size of the uplink grant being greater than or equal to the estimated size of the measurement report.

39. The UE of claim 35, wherein a location of an SR occasion in which the SR is transmitted is based on a location of a measurement gap containing the one or more PRS resources, a location of a measurement period containing the one or more PRS resources, a location of a PRS processing gap during which the one or more PRS resources are processed, a latency requirement for the measurement report, or any combination thereof.

40. The UE of claim 35, wherein:
a size of the uplink grant is smaller than an actual size of the measurement report, and
the at least the portion of the measurement report is transmitted as a first complete Long-Term Evolution (LTE) positioning protocol (LPP) message to enable the location server to begin processing the at least the portion of the measurement report before reception of a second portion of the measurement report.

41. The UE of claim 40, wherein the at least one processor is further configured to:
transmit, via the at least one transceiver, a first buffer status report (BSR) with the at least the portion of the measurement report to request a second uplink grant for at least the second portion of the measurement report; and
receive, via the at least one transceiver, the second uplink grant from the base station in response to the first BSR, the second uplink grant indicating second uplink resources on which to transmit the second portion of the measurement report; and
transmit, via the at least one transceiver, the second portion of the measurement report on the second uplink resources indicated by the second uplink grant, wherein the second portion of the measurement report is transmitted as a second complete LPP message.

42. The UE of claim 41, wherein the at least one processor is further configured to:
transmit, via the at least one transceiver, a second BSR with the second portion of the measurement report to indicate that the UE bas no more data to transmit.

43. The UE of claim 40, wherein the at least one processor is further configured to:
select a set of the positioning measurements for the at least the portion of the measurement report based on outlier rejection feedback from a positioning entity.

44. A base station, comprising:
a memory;
at least one transceiver; and
at least one processor communicatively coupled to the memory and the at least one transceiver, the at least one processor configured to:
forward, from a location server to a user equipment (UE), a positioning reference signal (PRS) configuration indicating one or more PRS resources to be measured by the UE during a positioning session between the UE and the location server; and
receive, via the at least one transceiver, measurement report payload related information for the UE for the positioning session.

45. The base station of claim 44, wherein:
the measurement report payload related information is received from the UE or the location server; and
the measurement report payload related information comprises the PRS configuration, an estimated size of the measurement report, or both.

46. The base station of claim 45, wherein the at least one processor is further configured to:
determine the estimated size of the measurement report based on an estimated number of positioning measurements indicated by the PRS configuration, a minimum number of measurements for the positioning session, a quality of service (QOS) level for the positioning session, outlier rejection results from a previous measurement report, PRS processing capabilities of the UE, or any combination thereof.

47. The base station of claim 44, wherein the at least one processor is further configured to:
receive, via the at least one transceiver, a scheduling request (SR) from the UE, the SR requesting an uplink grant for a measurement report for the UE to report positioning measurements to a location server involved in a positioning session with the UE;
transmit, via the at least one transceiver, the uplink grant to the UE in response to the SR, the uplink grant indicating uplink resources for the UE to transmit the measurement report;
receive, via the at least one transceiver, at least a portion of the measurement report from the UE on the uplink resources indicated by the uplink grant; and
forward the at least the portion of the measurement report to the location server.

48. The base station of claim 47, wherein:
a size of the uplink grant is based on an estimated size of the measurement report, and
the estimated size of the measurement report is based on the measurement report payload related information.

49. The base station of claim 48, wherein:
the SR is configured to indicate one of a plurality of different uplink grant sizes,
the size of the uplink grant is one uplink grant size of the plurality of different uplink grant sizes, and
the size of the uplink grant being based on the estimated size of the measurement report comprises the size of the uplink grant being greater than or equal to the estimated size of the measurement report.

50. The base station of claim 48, wherein:
the SR is one of a plurality of SRs,
each SR of the plurality of SRs is associated with an uplink grant having a different size,
each SR of the plurality of SRs is scheduled in a different SR occasion, and
the size of the uplink grant being based on the estimated size of the measurement report comprises the size of the uplink grant being greater than or equal to the estimated size of the measurement report.

51. The base station of claim 47, wherein a location of an SR occasion in which the SR is received is based on a location of a measurement gap containing the one or more PRS resources, a location of a PRS processing gap during which the one or more PRS resources are processed, a latency requirement for the measurement report, or any combination thereof.

52. The base station of claim 47, wherein:
the size of the uplink grant is smaller than an actual size of the measurement report, and
the at least the portion of the measurement report is transmitted as a first complete Long-Term Evolution (LTE) positioning protocol (LPP) message to enable the location server to begin processing the at least the portion of the measurement report before reception of a second portion of the measurement report.

53. The base station of claim 52, wherein the at least one processor is further configured to:
receive, via the at least one transceiver, a first buffer status report (BSR) with the at least the portion of the measurement report, the first BSR requesting a second uplink grant for at least the second portion of the measurement report; and
transmit, via the at least one transceiver, the second uplink grant to the UE in response to the first BSR, the second uplink grant indicating second uplink resources on which to transmit the second portion of the measurement report; and
receive, via the at least one transceiver, the second portion of the measurement report on the second uplink resources indicated by the second uplink grant, wherein the second portion of the measurement report is transmitted as a second complete LPP message.

54. The base station of claim 52, wherein the at least one processor is further configured to:
transmit, via the at least one transceiver, a first buffer status report (BSR) on a portion of the first uplink resources to request a second uplink grant for at least the second portion of the measurement report; and
receive, via the at least one transceiver, the second uplink grant from the base station in response to the first BSR, the second uplink grant indicating second uplink resources on which to transmit the second portion of the measurement report; and
transmit, via the at least one transceiver, the second portion of the measurement report on the second uplink resources indicated by the second uplink grant, wherein the second portion of the measurement report is transmitted as a second complete LPP message.

55. The base station of claim 51, wherein the at least one processor is further configured to:
select a set of the positioning measurements for the first portion of the measurement report based on outlier rejection feedback from a positioning entity.

56. A user equipment (UE), comprising:
a memory;
at least one transceiver; and
at least one processor communicatively coupled to the memory and the at least one transceiver, the at least one processor configured to:
receive, via the at least one transceiver, from a location server, a positioning reference signal (PRS) configuration indicating one or more PRS resources to be measured by the UE during a positioning session;
obtain positioning measurements of the one or more PRS resources based on the PRS configuration;
transmit, via the at least one transceiver, to a base station, a scheduling request (SR) for a first uplink grant for at least a first portion of a measurement report for the positioning measurements;
receive, via the at least one transceiver, the first uplink grant from the base station in response to the SR, the first uplink grant indicating first uplink resources on which to transmit the first portion of the measurement report; and
transmit, via the at least one transceiver, the first portion of the measurement report on the first uplink resources indicated by the first uplink grant, wherein the first portion of the measurement report is transmitted as a first complete Long-Term Evolution (LTE) positioning protocol (LPP) message to enable the location server to begin processing the first portion of the measurement report before reception of a second portion of the measurement report.

57. The UE of claim 55, wherein the at least one processor is further configured to:
transmit, via the at least one transceiver, a second BSR on a portion of the second uplink resources to indicate that the UE has no more data to transmit.

58. The UE of claim 56, wherein the positioning entity is a component of the UE or the location server.

59. A location server, comprising:
a memory;
at least one transceiver; and
at least one processor communicatively coupled to the memory and the at least one transceiver, the at least one processor configured to:
transmit, via the at least one transceiver, to a user equipment (UE), a positioning reference signal (PRS) configuration indicating one or more PRS resources to be measured by the UE during a positioning session;
transmit, via the at least one transceiver, to a base station serving the UE, measurement report payload related information based on the PRS configuration; and
receive, via the at least one transceiver, from the UE via the base station, at least a portion of a measurement report, the at least the portion of the measurement report including positioning measurements of the one or more PRS resources.

60. The location server of claim 59, wherein the measurement report payload related information comprises the PRS configuration, an estimated size of the measurement report, or both.
